(19) United States
(12) Patent Application Publication
(10) Pub. No.: US 2013/0181591 A1
(43) Pub. Date: Jul. 18, 2013

(54) PRE-FABRICATED BACKSPLASH PANEL, PRE-FABRICATED BASE, PRE-FABRICATED CABINETS AND METHOD OF INSTALLING A PRE-FABRICATED ENVIRONMENT

(71) Applicant: Louis BERGEVIN, Notre-Dame de l'Ile Perrot (CA)

(72) Inventor: Louis BERGEVIN, Notre-Dame de l'Ile Perrot (CA)

(21) Appl. No.: 13/740,511

(22) Filed: Jan. 14, 2013

Related U.S. Application Data
(60) Provisional application No. 61/586,169, filed on Jan. 13, 2012.

(51) Int. Cl. A47B 91/00; E04F 21/00; B32B 3/10; E04F 19/00

(52) U.S. Cl. CPC A47B 91/005; E04F 19/00; E04F 21/00; B32B 3/10
USPC 312/351.1; 52/390; 52/391; 52/741.1; 428/195.1

(57) ABSTRACT

The present document describes a pre-fabricated base for receiving a pre-fabricated cabinet having a bottom surface and a corresponding mating portion extending from the bottom surface comprising a semi-rigid frame for installation on a surface, the semi-rigid frame having an internal surface and an external surface; at least two adjustable supporting portions mounted on at least one of: the internal surface of the semi-rigid frame and the external surface of the semi-rigid frame for horizontally leveling the semi-rigid frame; and a male/female portion extending from the external surface of the semi-rigid frame for removably receiving the corresponding mating portion of the cabinet.

### CROSS-REFERENCE TO RELATED APPLICATIONS

This application claims priority under 35 USC §119(e) of U.S. provisional patent application 61/586,169, filed on Jan. 13, 2012, the specification of which is hereby incorporated by reference.

### BACKGROUND

(a) Field

The subject matter disclosed generally relates to pre-fabricated cabinets or vanities. More particularly, the subject matter disclosed relates to pre-fabricated backsplashes for kitchens and bathroom, to pre-fabricated bases, to pre-fabricated kitchen cabinets and/or bathroom vanities and to a method of installing a pre-fabricated environment.

(b) Related Prior Art

Kitchens and bathrooms are generally considered to be the most complex and costly rooms in the house to renovate or construct. Kitchens and bathrooms will typically require the services of a range of people, including plumber, electricians, gas fitters, carpenters and the like. Kitchens and bathrooms represent rooms in the house that cannot be easily renovated or constructed by even the most able home handyman, nor is it advised. Moreover, for an entrepreneur, it can be very expensive to bring many of these professionals on sites (i.e., kitchens and bathrooms to be renovated sites), since it requires that these professionals have their professional permits to be legally capable to work at construction sites. It is therefore a need to develop pre-fabricated cabinets and/or vanities that will require a reduced number of professionals and a reduced number of tools required to renovate or construct a bathroom and/or a kitchen environment.

It is also well known that after a few years, kitchen cabinets or bathroom vanities need to be replaced or at least require some renovations. Sometimes, this is required because these articles are damaged or often because a new look, following present trends, is desirable.

There are many reasons to renovate a kitchen or a bathroom, chief among them is a desire to create a room that is functional, that maximizes space and that is suited to the taste of the owner. Another important consideration is that a well-contracted or a well-renovated kitchen or bathroom will almost certainly add value to a property. For many, the state of the kitchen and the bathroom is one of the major determinants in purchasing home.

There are generally three ways to undertake a kitchen renovation:

1—Custom Design and Installation

Typically, a kitchen designer is employed to maximize the space and esthetics of the kitchen in consultation with the client. A custom-designed kitchen is not restricted by standard measurements or materials and it is for this reason that it is often the best option for small or oddly-shaped spaces. A custom designed and installed kitchen will generally be the most expensive renovation option. Furthermore, it takes many hours to install a custom designed kitchen at home. Additionally, when the renovations have started, there can be many issues on sites that will be harder to manage.

2—Pre-Fabricated Kitchen and Installation

There are many companies that specialize in pre-fabricated kitchens, including cupboards, draws and surfaces and range in quality and price from budget to high end. Using pre-fabricated components can save time and money, however, the client is restricted to standard-sized components (i.e., standard-sized kitchen and/or bathroom cabinets and/or vanities, standard-sized bases for receiving kitchen and/or bathroom cabinets and/or vanities) and materials. A professional kitchen designer can also be hired to make the best use of space using pre-fabricated components. Furthermore, it still takes many hours to install a pre-fabricated kitchen or a pre-fabricated vanity at home. Additionally, there is still a requirement to have an important number of professionals with their professional permits on sites since these types of kitchens and/or bathroom environment require professional construction skills and many tools (i.e., there is a need to adjust and attach to wall and/or floor the kitchen/bathroom cabinets and/or vanities, there is a need to adjust and attach to wall and/or floor the kitchen/bathroom cabinets and/or vanities).

3—Pre-Fabricated Kitchen and Self Installation

It is a budget option for a client to install its own pre-fabricated kitchen. However, it is often hard to prepare the installation by measuring the positioning of the kitchen cabinets and bathroom vanities on a wall surface and to make sure that these are level according to the ground surface. Furthermore, it can often be hard for a non-handy man to manage the installation of the kitchen and/or bathroom cabinets and/or vanities using a plurality of professional tools.

There is therefore a need for pre-fabricated kitchen cabinets or bathroom vanities allowing easy installation and less measure requirements and that does not require a lot of machinery and tools during installation.

Also, actually in a kitchen or a bathroom environment, a backsplash can transform a tired decor in few hours. There is a range of beautiful tiles available on the market in a variety of colors and patterns. However, installing a backsplash in a kitchen or in a bathroom is often long and takes many steps. First, there is a need to measure the wall space to determine the best fit for the selected tiles. After, there is a need to apply a wall tile adhesive to a small area on the wall. There is a need to perform small spots at a time to avoid the adhesive to dry. There is also a need, while installing the backsplash, to ensure that the tiles are straight and firmly pressed on the wall. A mix grout is then mixed in an appropriate bucket and applied to the tile surface using a sweeping pattern on a 45 degree angle to tile joints. After allowing a few minutes for drying, the bucket is filled with water and the surface grout is sponged off the tile. Thus, installation of a backsplash in the kitchen or in the bathroom environment may be long to perform and quite difficult for a non-home handyman.

There is therefore a need for a pre-fabricated backsplash panel to ensure the efficiency during the installation of a backsplash around kitchen cabinets and/or bathroom vanities.

### SUMMARY

According to an embodiment, there is provided a pre-fabricated backsplash panel for installation on a surface comprising: a semi-rigid panel having a mounting side, a decorative side and a predetermined shape, the mounting side of the semi-rigid panel is for installation on the surface; and at least one decorative surface mounted on the decorative side of the semi-rigid panel for allowing appearance transformation of the surface.

The mounting side of the semi-rigid panel may be for fixed installation or removable installation on the surface.

The at least one decorative surface may be fixedly mounted on the decorative side of the semi-rigid panel.

The at least one decorative surface may have a plurality of decorative surfaces having at least one pattern of decorative surfaces.

The mounting side of the semi-rigid panel may be mounted on the surface using glue, tile grout mortar, adhesive, organic adhesive, nails, screws, seal and any combination thereof.

According to another embodiment, there is provided a pre-fabricated base for receiving a pre-fabricated cabinet having a bottom surface and a corresponding mating portion extending from the bottom surface comprising: a semi-rigid frame for installation on a surface, the semi-rigid frame having an internal surface and an external surface; at least two adjustable supporting portions mounted on at least one of: the internal surface of the semi-rigid frame and the external surface of the semi-rigid frame for horizontally leveling the semi-rigid frame; and a male/female portion extending from the external surface of the semi-rigid frame for removably receiving the corresponding mating portion of the cabinet.

The at least two adjustable supporting portions may be mounted on the semi-rigid frame using a screw, a nail, glue, mating connectors, a snap and any combination thereof.

The pre-fabricated base of may further comprise a semi-rigid transverse section transversally mounted on the internal surface of the semi-rigid frame for allowing the semi-rigid frame to be substantially rigid.

The semi-rigid frame may be made of wood, plywood, a polymeric material, a metallic material and any combination thereof.

The pre-fabricated base may further comprise a decorative molding having a corresponding mating portion for mounting on the male/female portion extending from the external surface of the semi-rigid frame.

The semi-rigid frame may define a plurality of sides and at least one of the plurality of sides may comprise a plurality of adjustable members for allowing the semi-rigid frame to extend from a retracted position to an extended position.

The plurality of adjustable members may comprise two adjustable members for allowing the semi-rigid frame to extend from a retracted position to an extended position.

Each one of the plurality of adjustable members may comprise at least one mating connector for slidably connecting with a corresponding mating connector of an adjacent one of the plurality of adjustable members.

The plurality of adjustable members may comprise three adjustable members for allowing the semi-rigid frame to extend from a retracted position to an extended position.

The semi-rigid transverse section transversally mounted on the internal surface of the semi-rigid frame may further comprise a plurality of adjustable members for allowing the semi-rigid frame to extend from a retracted position to an extended position.

Each one of the plurality of adjustable members of the semi-rigid transverse section may comprise at least one mating connector for slidably connecting with a corresponding mating connector of an adjacent one of the plurality of adjustable members the semi-rigid transverse section.

According to another embodiment, there is provided a method for installation of a pre-fabricated environment having at least one bottom pre-fabricated cabinet comprising the steps of: a) horizontally leveling a pre-fabricated base on a surface; and b) mounting at least one bottom pre-fabricated cabinet on the pre-fabricated base, the at least one bottom pre-fabricated cabinet having a bottom surface, a top surface and a corresponding mating portion extending from the bottom surface for removably receiving the male/female portion of the pre-fabricated base.

The method may further comprise a step c) of mounting at least one guiding bar on a wall surface at a specific measured distance from the top surface of the at least one bottom pre-fabricated cabinet.

The method may further comprise a step d) of mounting at least one top pre-fabricated cabinet on the at least one guiding bar.

The method may further comprise the step of mounting a counter surface on the top surface of the at least one bottom pre-fabricated cabinet.

The method may further comprise the step of mounting a pre-fabricated backsplash panel on the wall surface over the top surface of the at least one bottom pre-fabricated cabinet.

The pre-fabricated base mounted on the surface may be fixed on the surface.

The method may further comprise the step of mounting at least one decorative molding adjacent to the pre-fabricated base installed on the surface or directly on the pre-fabricated base.

The step of horizontally leveling a pre-fabricated base on a surface may comprise one of: laterally sizing the pre-fabricated base, horizontally sizing the pre-fabricated base and laterally and horizontally sizing the pre-fabricated base.

According to another embodiment, there is provided a kit for installation of a pre-fabricated environment having at least one bottom pre-fabricated cabinet comprising: a pre-fabricated base having a male/female portion and adjustable portions for horizontal leveling; and at least one bottom pre-fabricated cabinet to be mounted on the pre-fabricated base, the at least one bottom pre-fabricated cabinet having a bottom surface, a top surface and a corresponding mating portion extending from the bottom surface to removably receive the male/female portion of the pre-fabricated base.

The kit may further comprise at least one guiding bar to be mounted on a wall surface at a specific measured distance from the top surface of the at least one bottom pre-fabricated cabinet.

The kit may further comprise at least one top pre-fabricated cabinet to be mounted on the at least one guiding bar.

The kit may further comprise a counter surface to be mounted on the top surface of the at least one bottom pre-fabricated cabinet.

The kit may further comprise a pre-fabricated backsplash panel to be mounted on the wall surface over the top surface of the at least one bottom pre-fabricated cabinet.

The kit may further comprise at least one decorative molding to be mounted adjacent to the pre-fabricated base installed on the surface or directly on the pre-fabricated base.

The pre-fabricated base may comprise adjustable members for allowing the semi-rigid frame to extend from a retracted position to an extended position.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a front elevation view of a pre-fabricated backsplash panel in accordance with an embodiment;

FIG. 2 is a perspective view of a pre-fabricated base for receiving a pre-fabricated cabinet in accordance with another embodiment;

FIG. 3 is a top perspective view of the pre-fabricated base of FIG. 2;

FIG. 4 is close-up view of the pre-fabricated base of FIG. 2;

FIG. 5 is a bottom plan view of the pre-fabricated base of FIG. 2;

FIG. 6 is an elevation side view of a pre-fabricated base and its corresponding pre-fabricated cabinet in accordance with another embodiment;

FIG. 7 is an elevation front view of the pre-fabricated base of FIG. 6;

FIG. 8 is an elevation side view of a pre-fabricated base and its corresponding decorative molding in accordance with another embodiment;

FIG. 9 is an elevation side view of a pre-fabricated base and the representation of the installation of its corresponding decorative molding in accordance with another embodiment;

FIG. 10 is an elevation side view of a pre-fabricated base and the representation of the installation of a corresponding cabinet in accordance with another embodiment;

FIG. 11 illustrates a method for installation of a pre-fabricated environment in accordance with another embodiment; and

FIGS. 12-13 illustrate the step of leveling a pre-fabricated base installed on the surface in accordance with another embodiment;

FIG. 14 illustrates the step of fixing the leveled pre-fabricated cabinet on the surface in accordance with another embodiment;

FIGS. 15, 16 and 17 illustrate the step of removably installing pre-fabricated cabinets on the pre-fabricated base in accordance with another embodiment;

FIG. 18 illustrates the step of mounting a counter surface on the pre-fabricated cabinets installed on the pre-fabricated base in accordance with another embodiment;

FIG. 19 illustrates the step of measuring a distance from the top surface of one pre-fabricated cabinets in accordance with another embodiment;

FIG. 20 illustrates the step of mounting a pre-fabricated backsplash panel on the wall surface over the top portion of a pre-fabricated cabinet in accordance with another embodiment;

FIG. 21 illustrates the step of mounting a guiding bar on a wall surface a the specific measured distance from the top surface of a pre-fabricated cabinet in accordance with another embodiment;

FIGS. 22-23 illustrate the step of removably mounting a pre-fabricated top cabinet on a guiding bar in accordance with another embodiment;

FIG. 24 illustrates the step of installing a decorative adjustable molding adjacent to the pre-fabricated base installed on the surface in accordance with another embodiment;

FIG. 25 is a top perspective view of an adjustable pre-fabricated base for receiving a pre-fabricated cabinet, the adjustable pre-fabricated base being in its extended position in accordance with another embodiment;

FIG. 26 is a top perspective view of the adjustable pre-fabricated base for receiving a pre-fabricated cabinet of FIG. 25, the adjustable pre-fabricated base being in its retracted position in accordance with another embodiment;

FIG. 27 is a perspective view of a first slidable member removably connected to a second slidable member for allowing the adjustable pre-fabricated base to slide and/or to extend from the extended position to the retracted position in accordance with another embodiment;

FIG. 28 is a perspective view of the first slidable member and of the second slidable member of FIG. 24;

FIG. 29 is a top plan view of an adjustable pre-fabricated base for receiving a pre-fabricated cabinet, the adjustable pre-fabricated base being in its retracted position in accordance with another embodiment;

FIG. 30 illustrates the extension of the adjustable pre-fabricated base (front/rear) in accordance with another embodiment;

FIG. 31 illustrates the extension of the adjustable pre-fabricated base (side/side) in accordance with another embodiment; and

FIG. 32 is a top plan view of an adjustable pre-fabricated base for receiving a pre-fabricated cabinet, the adjustable pre-fabricated base being in its extended position in accordance with another embodiment.

It will be noted that throughout the appended drawings, like features are identified by like reference numerals.

### DETAILED DESCRIPTION OF THE PREFERRED EMBODIMENTS

There are disclosed herein a pre-fabricated backsplash panel, a pre-fabricated base for receiving a pre-fabricated cabinet, an adjustable pre-fabricated base for receiving a pre-fabricated cabinet, a method for installation of a pre-fabricated environment (a kitchen environment, a bathroom environment and the like) and a kit for installation of a pre-fabricated environment (i.e., a kitchen environment, a bathroom environment and the like).

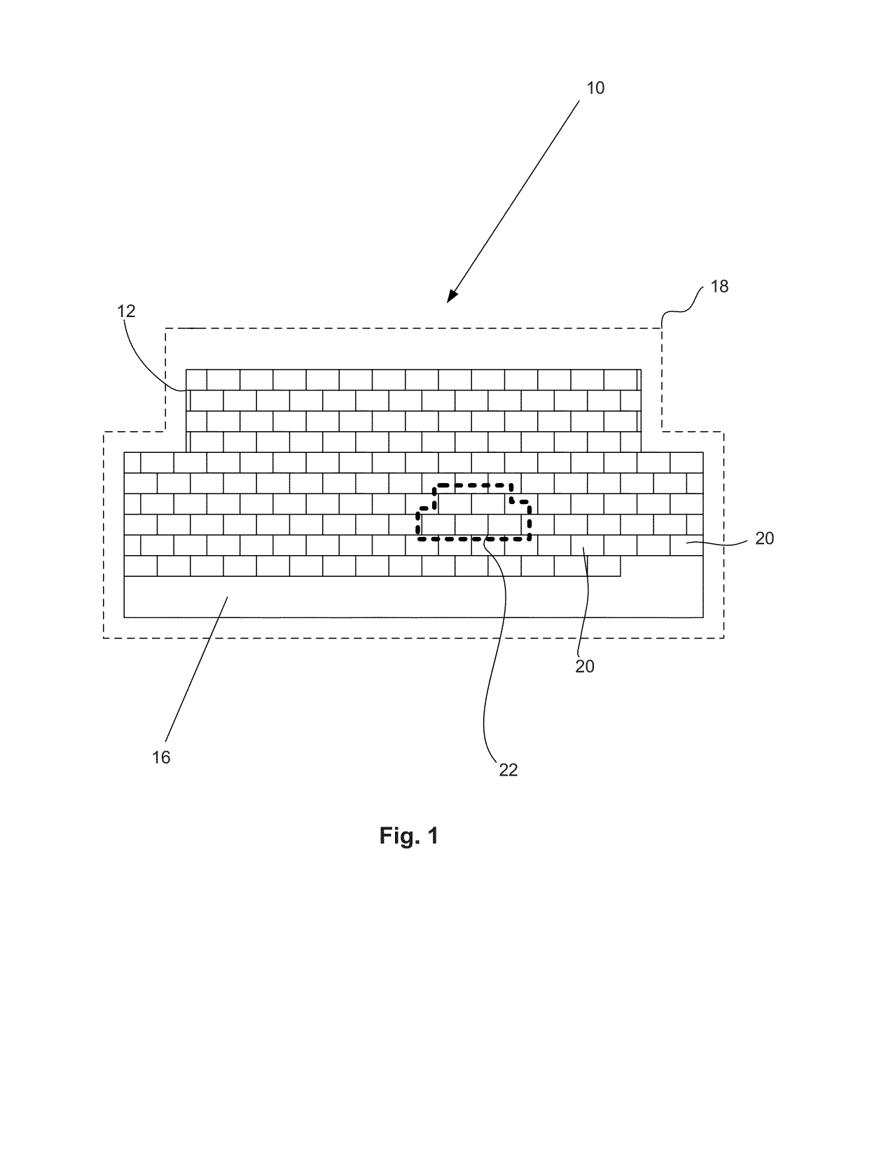

Referring now to the drawings, and more particularly to FIG. 1, there is shown a front elevation view of a pre-fabricated backsplash panel 10 in accordance with an embodiment. The pre-fabricated backsplash panel 10 is for installation on a surface (not shown). The surface may be a wall surface or any other suitable surface for receiving a pre-fabricated backsplash panel (i.e., a floor surface in a kitchen environment or in a bathroom environment, a shower or a bath wall or surface in a bathroom environment and the like). The pre-fabricated backsplash panel 10 includes a semi-rigid panel 12. The semi-rigid panel 12 of the pre-fabricated backsplash panel 10 has a mounting side (not shown) (i.e., the side that is to be mounted on the wall or on the floor surface), a decorative side 16 and a predetermined shape 18. It is to be noted that the mounting side (not shown) of the semi-rigid panel 12 is to be mounted on the surface (not shown). Also, the pre-fabricated backsplash panel 10 includes at least one decorative surface 20 mounted on the decorative side 16 of the semi-rigid panel 12. The decorative surfaces 20 (FIG. 1) of the pre-fabricated backsplash panel 10 allow appearance transformation of the surface (not shown) (i.e., of the wall or the floor surface of the kitchen or of the bathroom environment).

According to another embodiment, the decorative surface 20 of the pre-fabricated backsplash panel 10 may be, without limitations, a tile, a ceramic tile, a brick tile, a glass tile, a glass panel, a polymeric tile, a wall covering surface, a counter covering surface, an outdoor tile, an indoor tile, a black board panel, a flooring surface tile and the like.

According to another embodiment, the semi-rigid panel 12 of the pre-fabricated backsplash panel 10 may include a plurality of semi-rigid panels 12 to cover the surface (not shown) having a predetermined shape 18. It is to be noted that the surface receiving the pre-fabricated backsplash panel 10 may be, without limitation, a wall surface, a counter surface, a floor surface, a cabinet surface, a vanity surface, a kitchen cabinet surface, a bathroom cabinet surface, a kitchen vanity surface, a bathroom vanity surface, a cupboard surface, a filing cabinet surface, a dresser surface, a garage cabinet surface and the like. However, in a preferred embodiment, the surface (not shown) is a wall surface in a kitchen environment or in a bathroom environment and the pre-fabricated backsplash panel is to be installed adjacent to pre-fabricated cabinets.

According to a further embodiment, the decorative surfaces 20 of the pre-fabricated backsplash panel 10 may include at least one predetermined pattern of decorative surfaces, such as the predetermined pattern 22 of decorative surfaces 20 (FIG. 1). It is to be noted that the pre-fabricated backsplash panel 10 may include a plurality of predetermined patterns 22 on its decorative side 16.

According to another embodiment, the mounting side (not shown) of the semi-rigid panel 12 may be mounted on the surface (not shown) using, without limitations, glue, tile grout mortar, adhesive, organic adhesive, nails, screws, seal, male and female mating connectors (i.e., male mating connectors on the mounting side and corresponding female mating connectors on the surface) and the like.

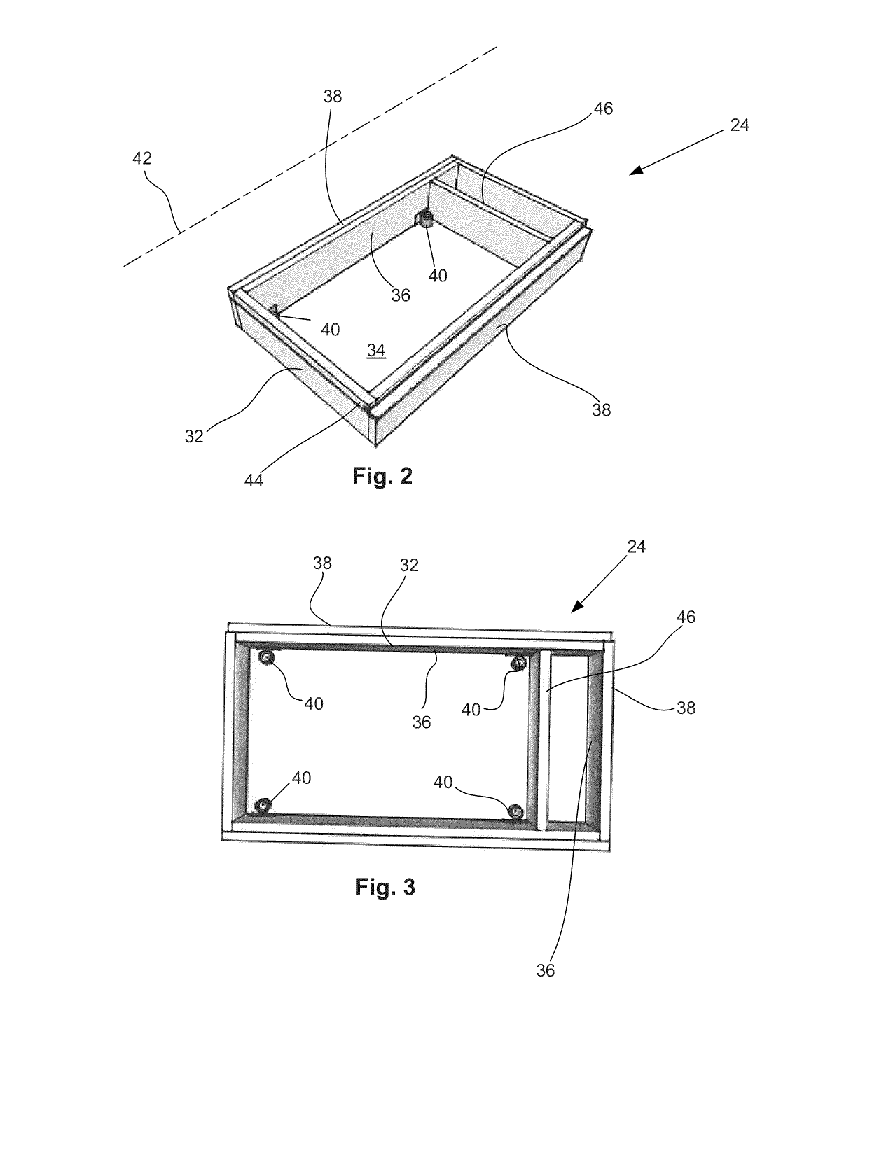

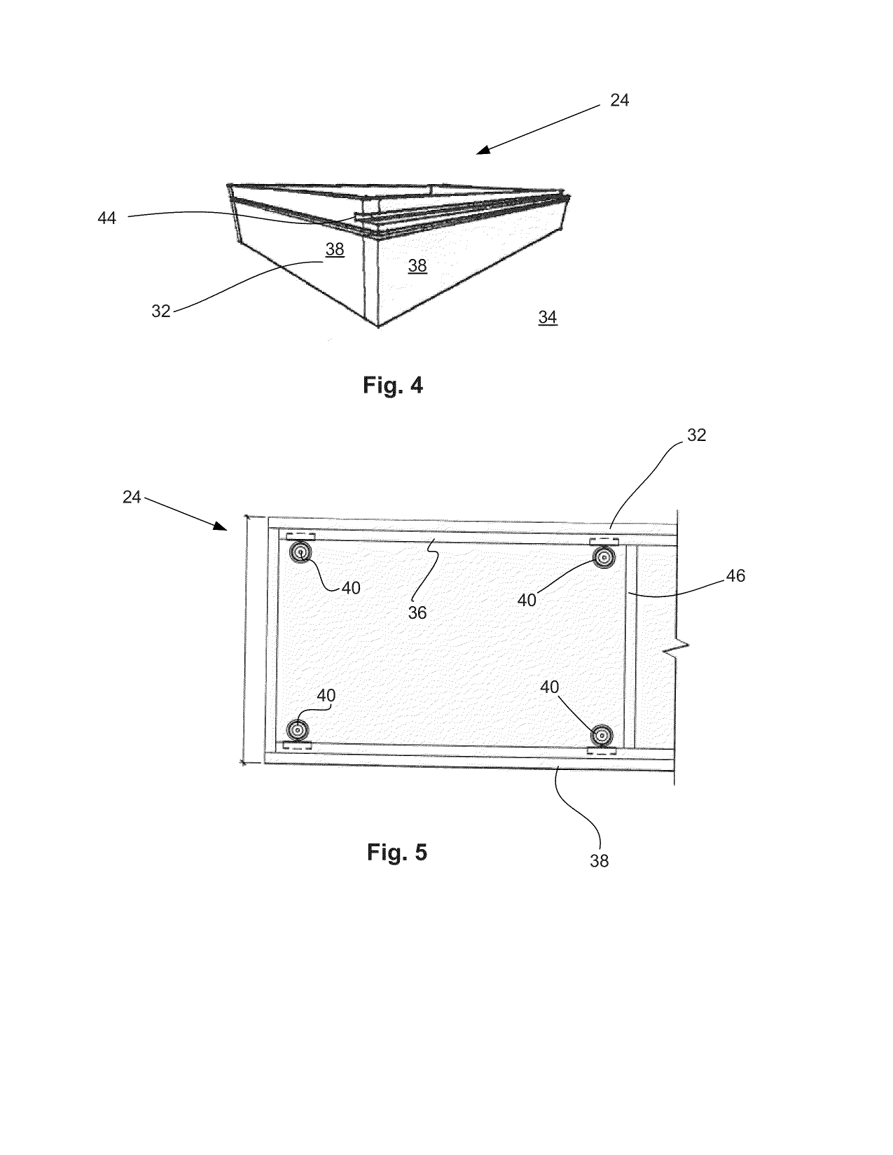

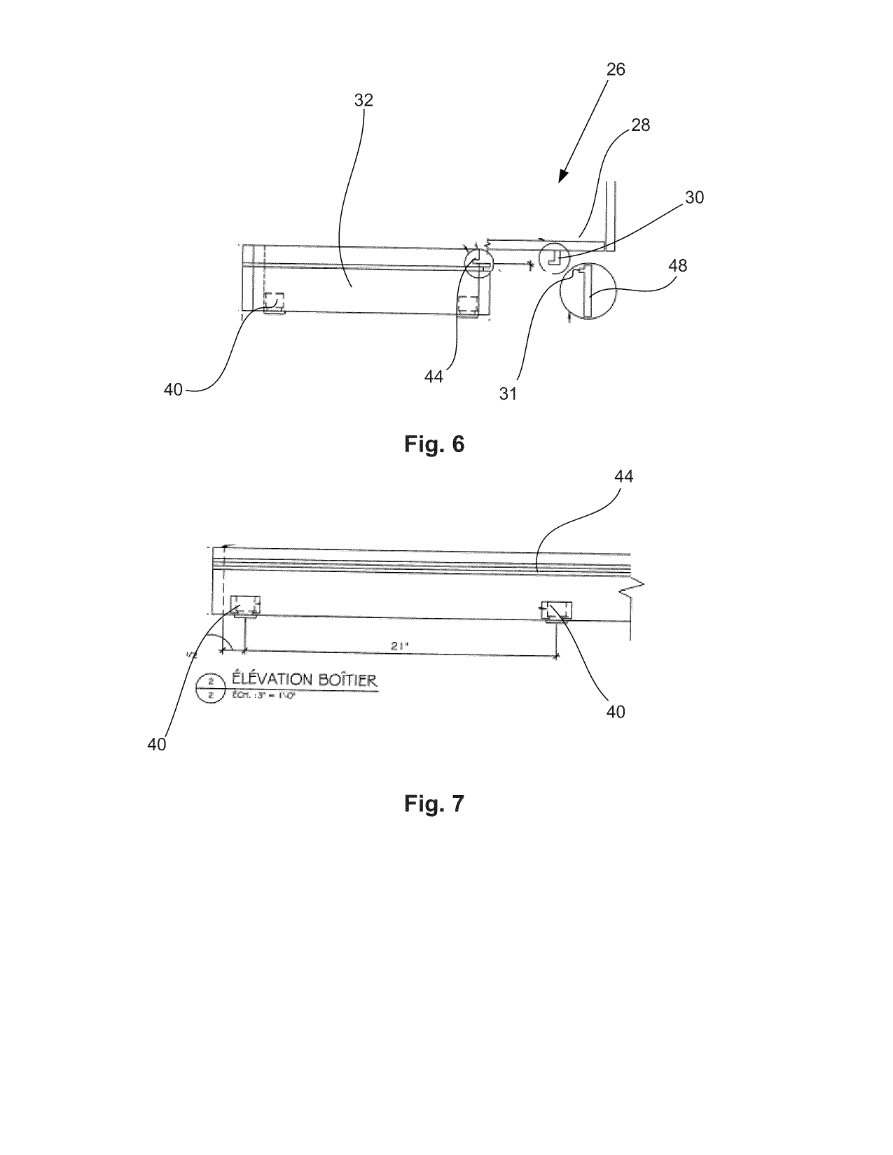

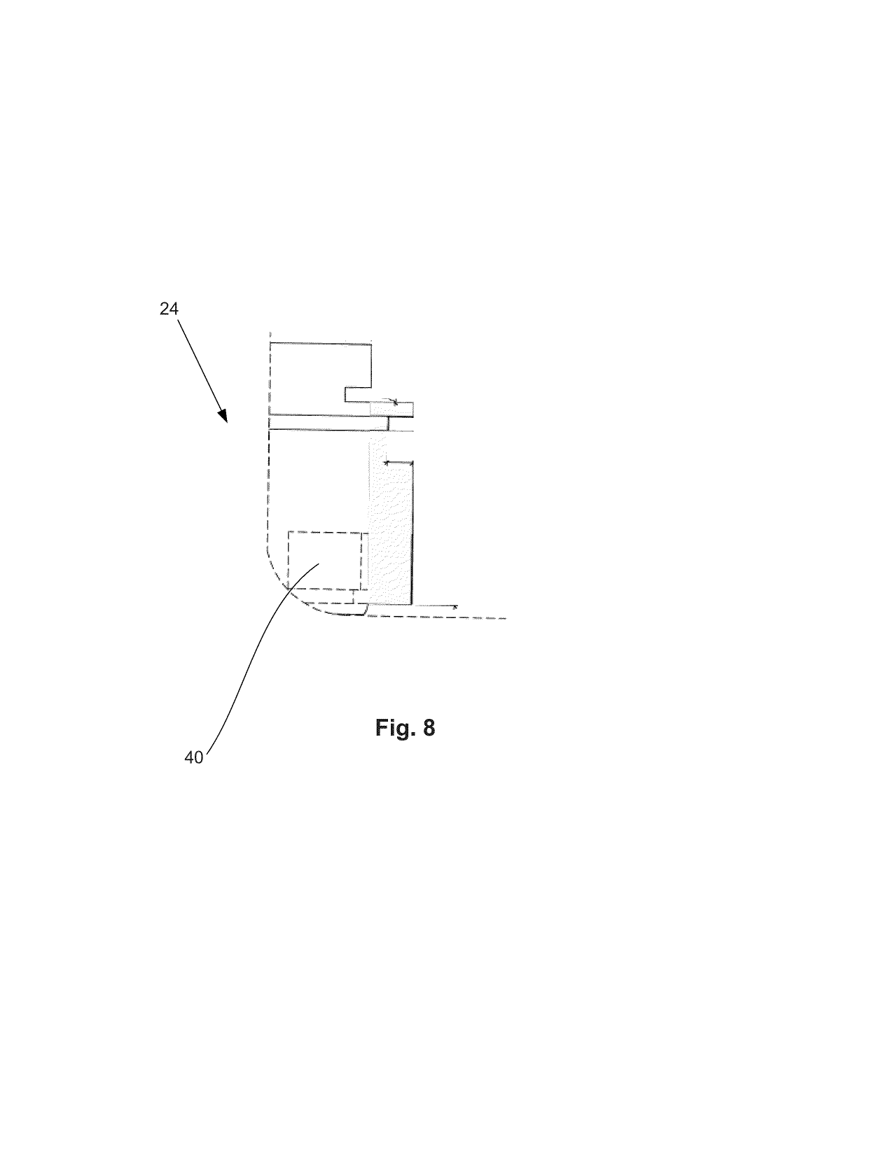

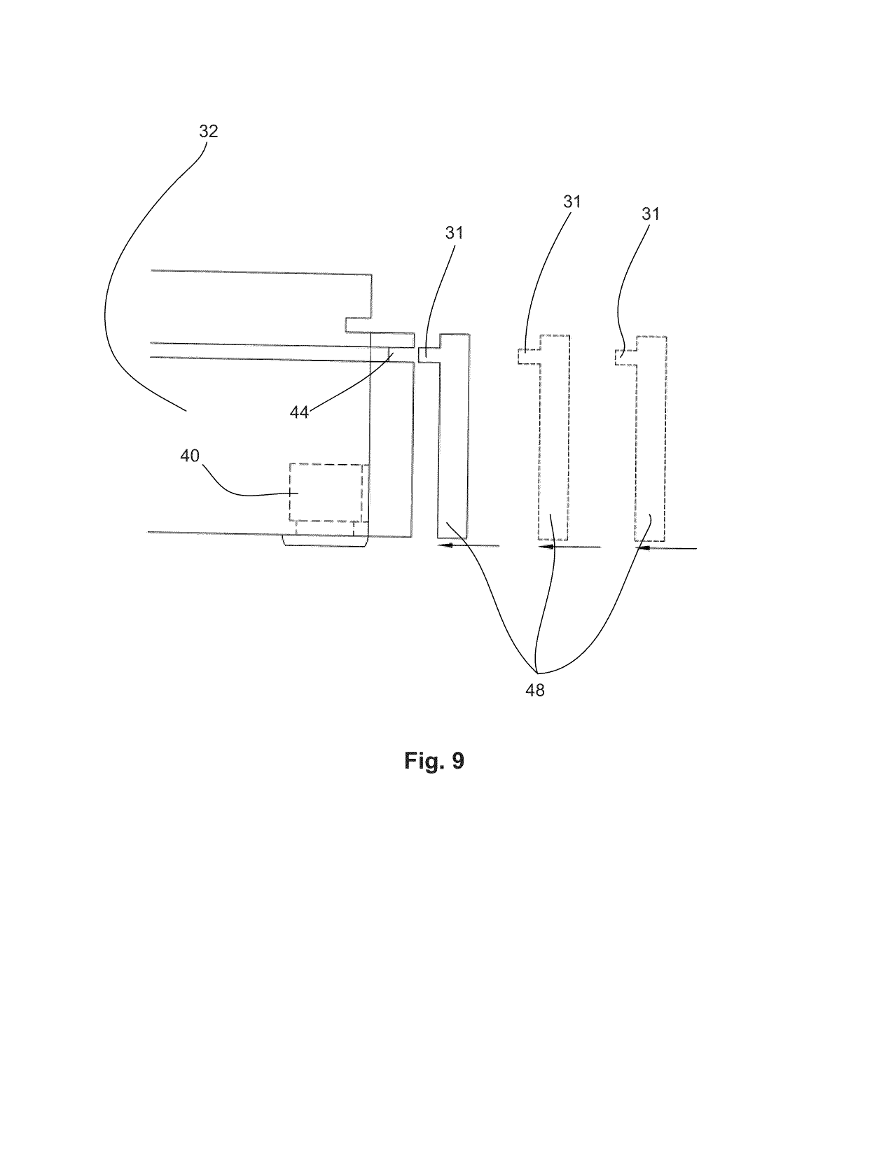

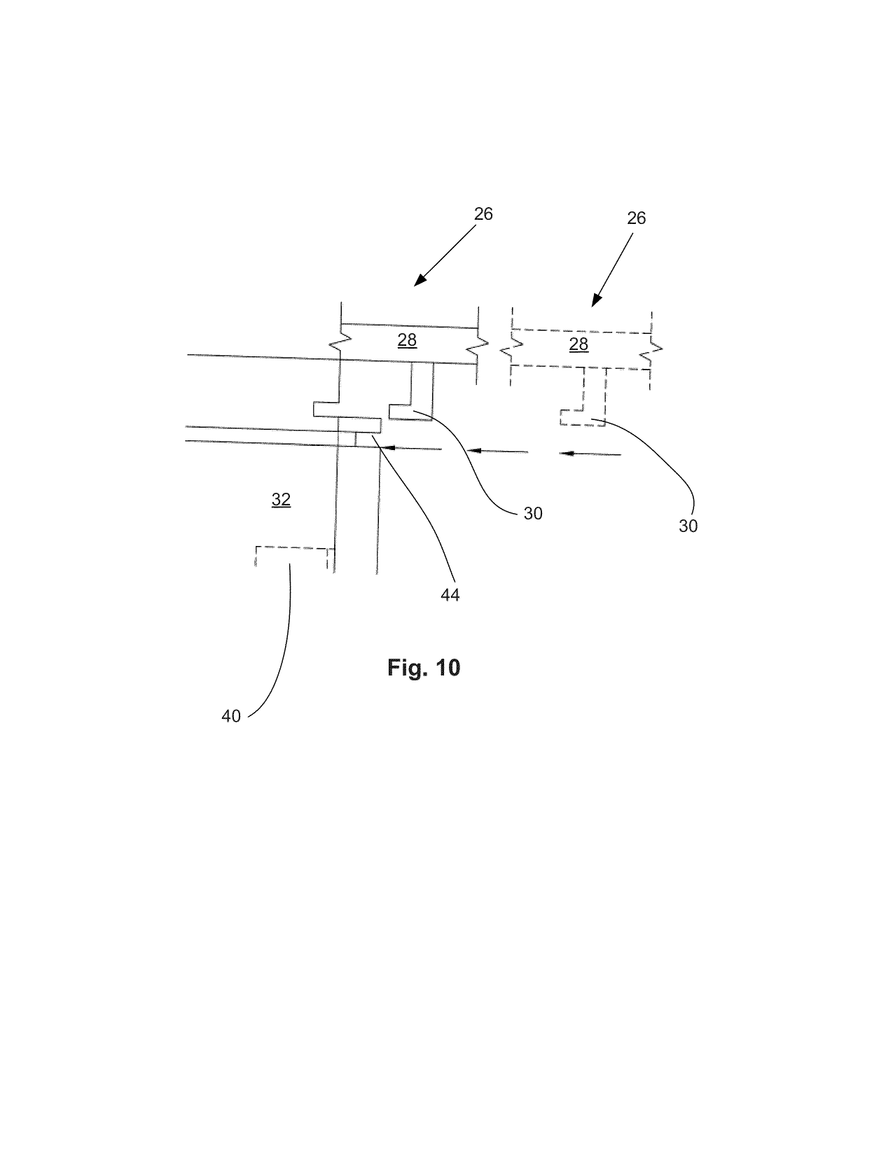

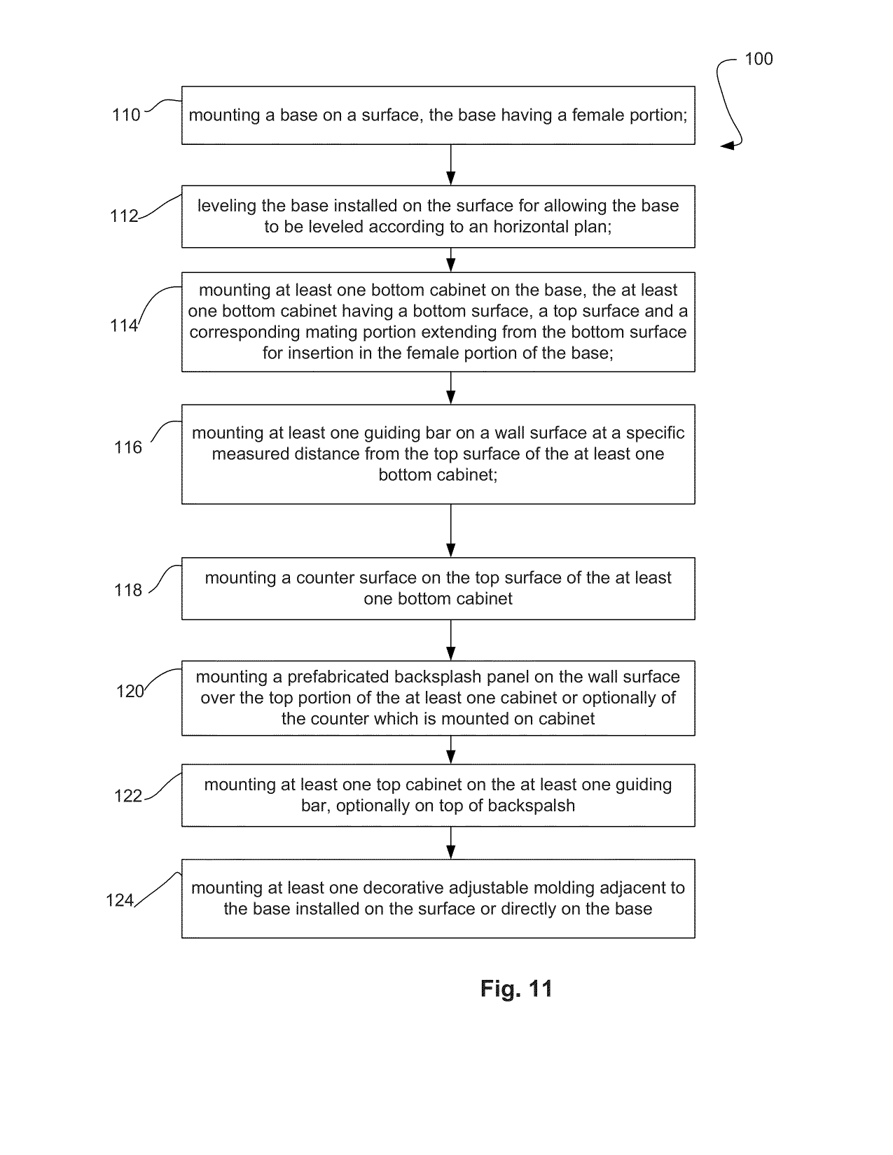

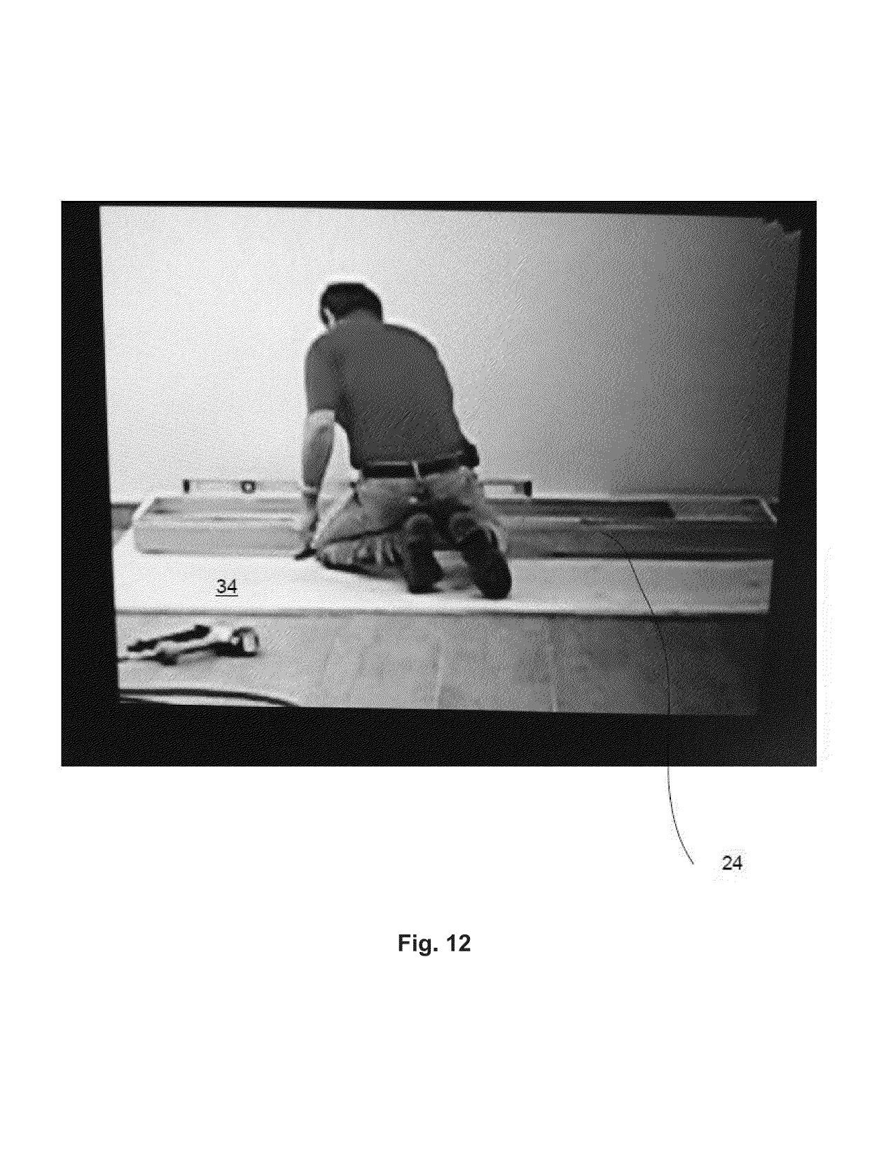

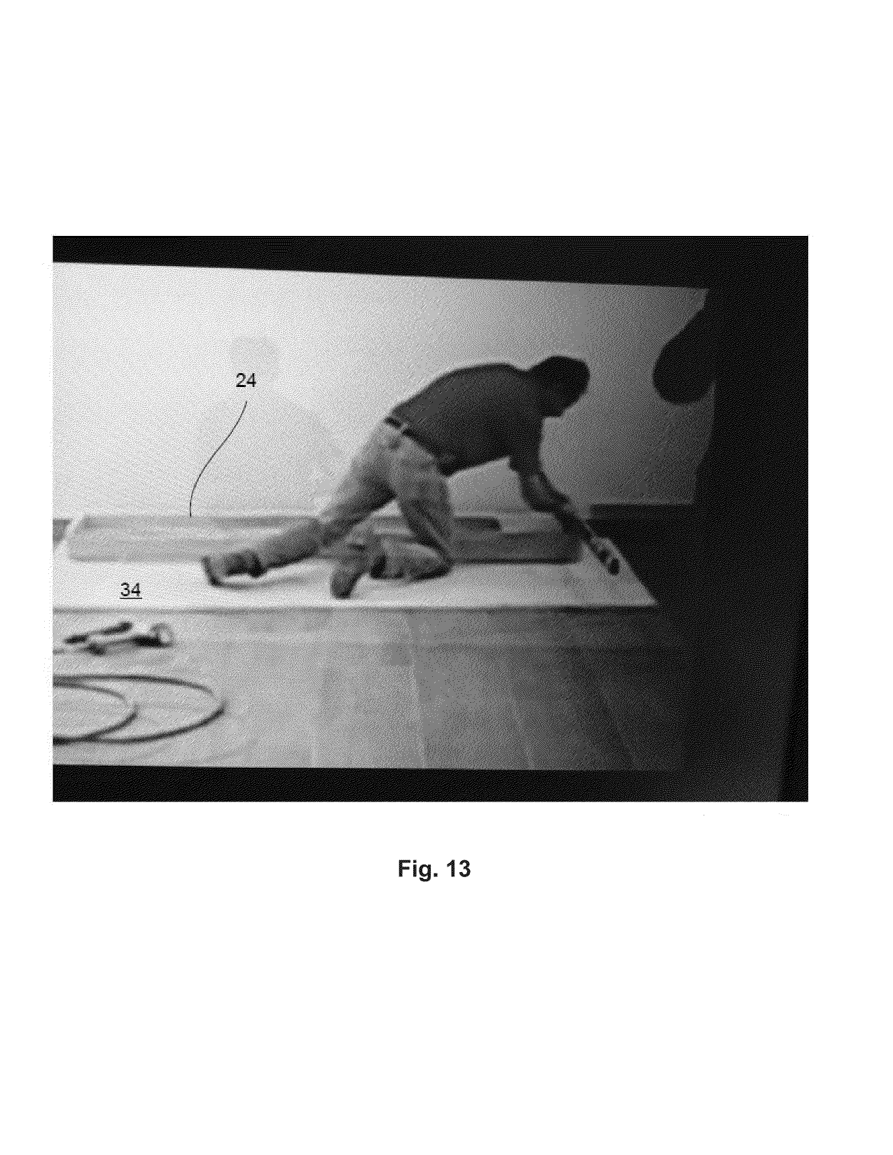

Referring now to FIGS. 2 to 10, there is shown a pre-fabricated base 24 for receiving a pre-fabricated cabinet 26 (or a pre-fabricated vanity 26) in accordance with another embodiment. The pre-fabricated cabinet 26 to be received on the pre-fabricated base 24 has a bottom surface 28 and a corresponding mating portion 30 extending (or downwardly extending) from the bottom surface 28. The pre-fabricated base 24 includes a semi-rigid frame 32 for installation on a surface 34 (FIG. 4). The semi-rigid frame 32 has an internal surface 36 and an external surface 38. The pre-fabricated base 24 also includes at least two adjustable supporting portions 40 mounted on the semi-rigid frame 32. It is to be noted that the embodiments shown in FIGS. 2 to 10 includes four adjustable supporting portions 40. In another embodiment, the at least two adjustable supporting portions 40 may be mounted on the internal surface 36 semi-rigid frame 32. It is to be noted that other configurations are also possible. Those adjustable supporting portions 40 allow the semi-rigid frame 32 to be leveled according to a horizontal plan 42. Thus, the pre-fabricated base may be installed on any surface even if the surface is not leveled (i.e., in a relatively old house kitchen or bathroom environment or in a non well constructed house kitchen or bathroom environment). The pre-fabricated base 24 also includes a male and/or female portion 44 (i.e., a mating connector), extending from the external surface 38 (or projecting from the external surface 38 of the pre-fabricated base 24) of the semi-rigid frame 32. The male and/or female portion 44 is configured to receive the corresponding mating portion 30 (i.e., to slidably and/or removably receive the corresponding mating portion 30) of the pre-fabricated cabinet 26 and thereby allows the pre-fabricated cabinet 26 to be removably mounted on the semi-rigid frame 32.

According to another embodiment, the surface 34 may be, without limitation, a floor surface, a kitchen floor surface, a bathroom floor surface, a counter surface, a garage surface, an outdoor surface, an indoor surface and the like. However, in a preferred embodiment, the surface 34 is the floor surface of a kitchen environment or of a bathroom environment, which will receive pre-fabricated cabinet(s).

According to a further embodiment, the adjustable supporting portions 40 are mounted on the semi-rigid frame 32 using a fastener including, without limitation, a screw, a nail, glue, a snap, mating connectors on semi-rigid frame 32 and corresponding mating connector on adjustable supporting portions 40 and the like.

In another embodiment, the pre-fabricated base 24 may include a semi-rigid transverse section 46 transversally mounted on the internal surface 36 of the semi-rigid frame 32 and the semi-rigid transverse section 46 may allow the semi-rigid frame 32 to be substantially rigid. In the pre-fabricated base 24, the semi-rigid frame 32 may be made, without limitation, of wood, of plywood, of a polymeric material, of a metallic material, of any combinations and of any other suitable materials.

In a further embodiment, the pre-fabricated base 24 may further include a decorative molding 48 which has a corresponding mating portion 31 for mounting on the corresponding male and/or female portion 44 extending from the external surface 38 of the semi-rigid frame 32. The corresponding mating portion 31 may extend on a perpendicularly manner from the decorative molding 48 such that the decorative molding 48 may be installed via a lateral displacement of the decorative molding 48 towards the pre-fabricated base 24.

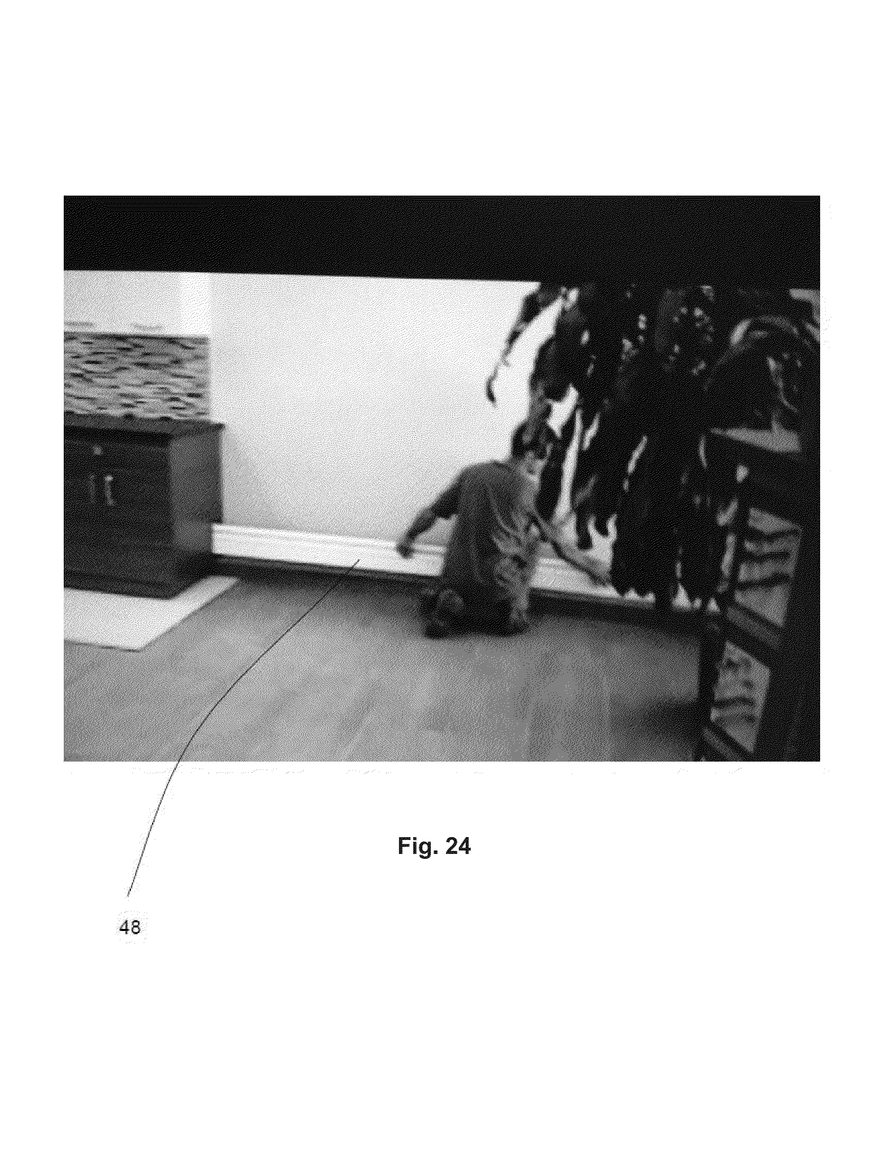

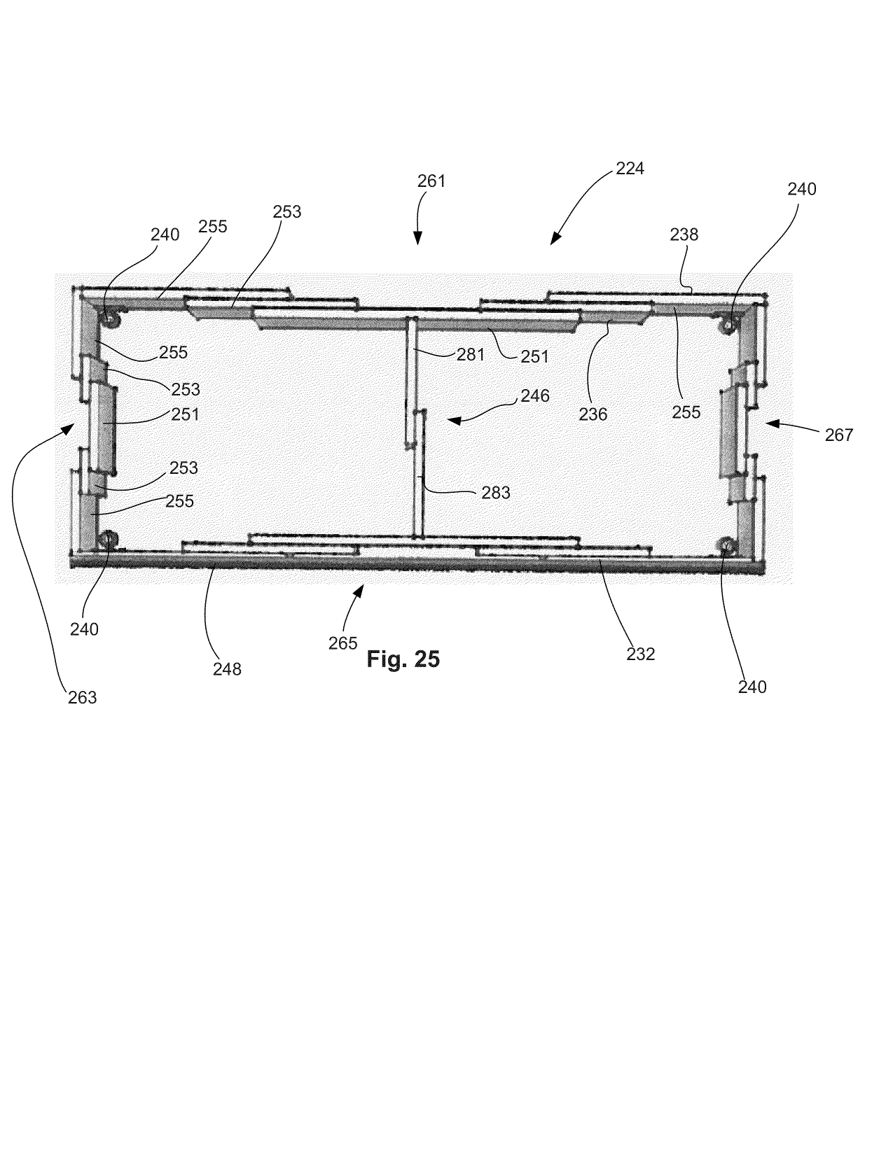

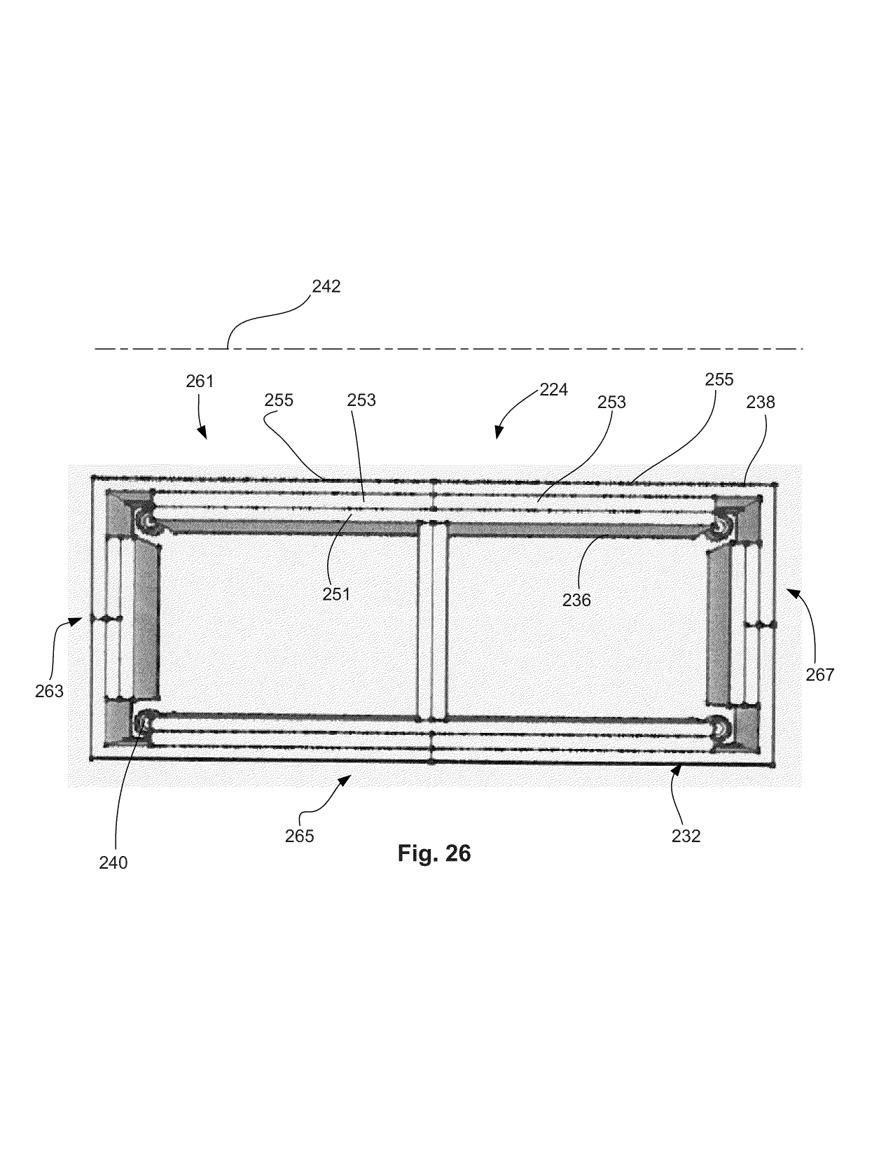

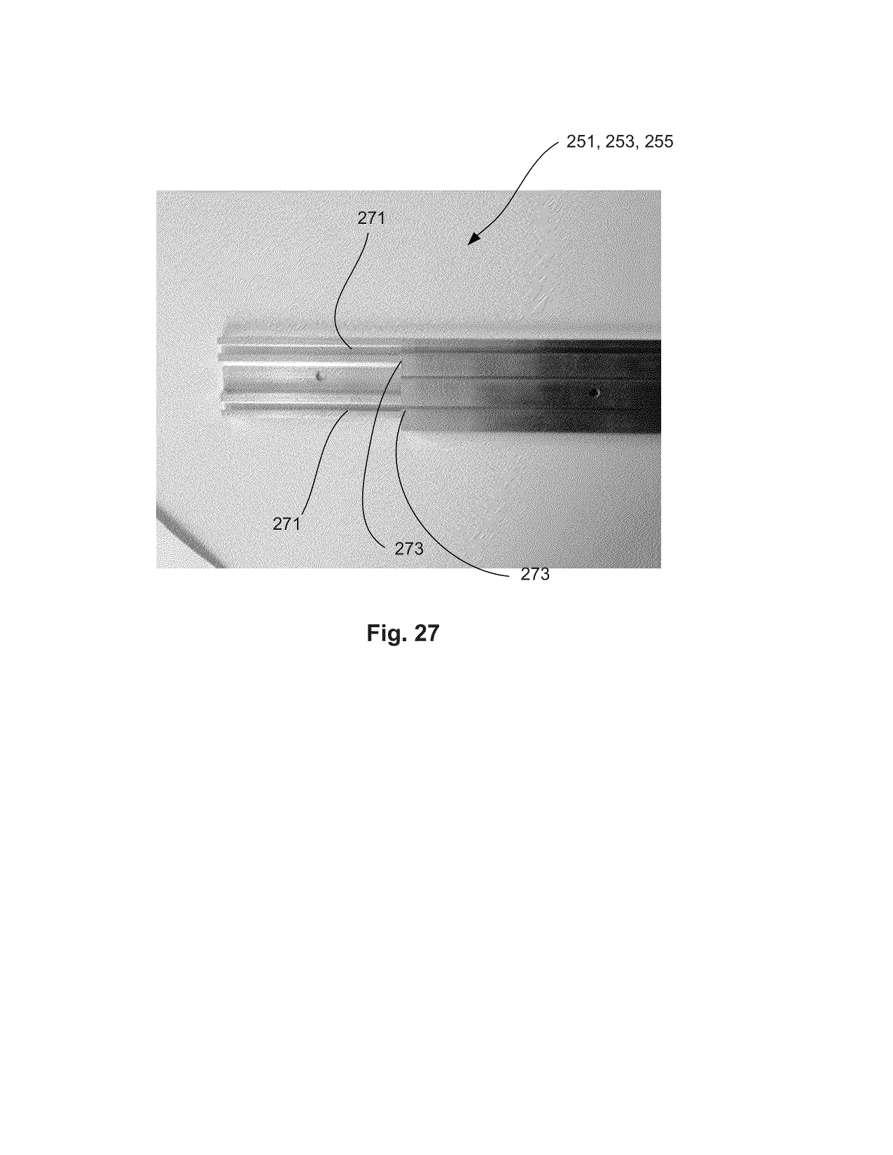

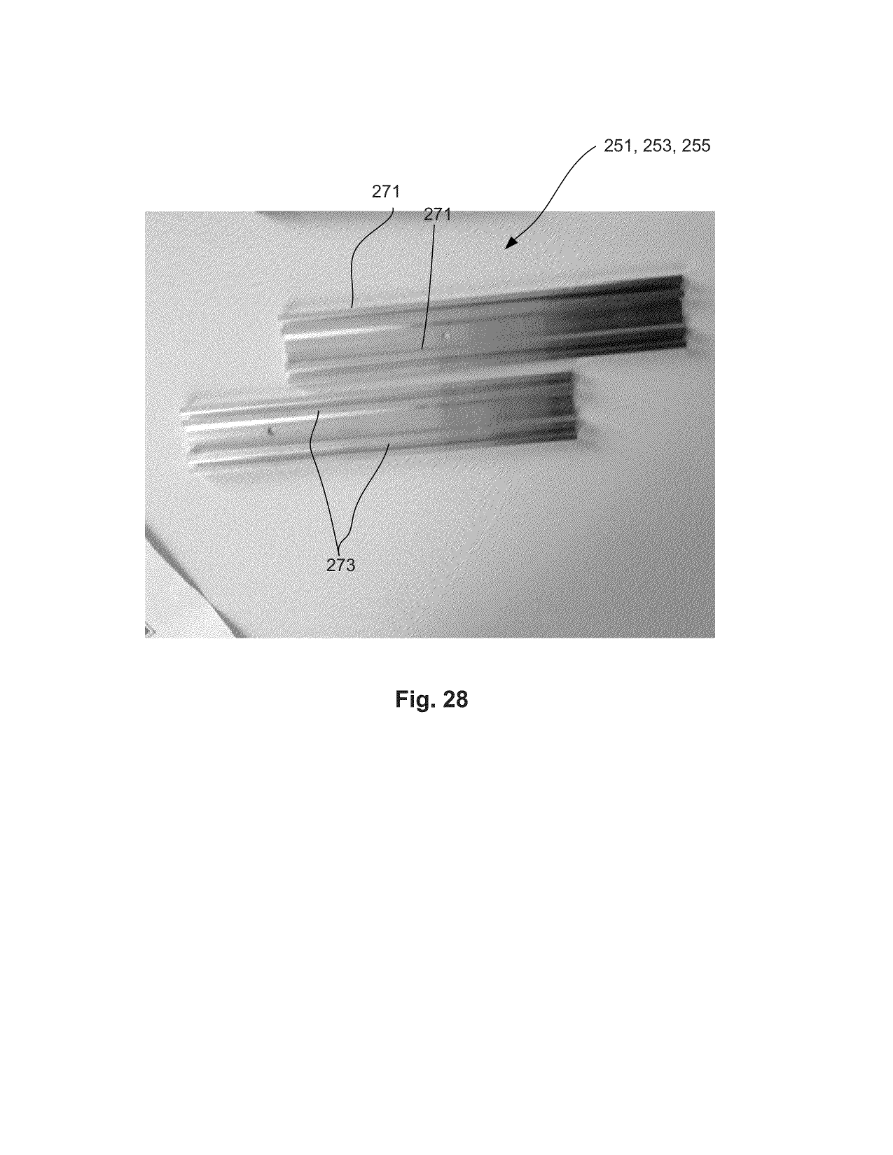

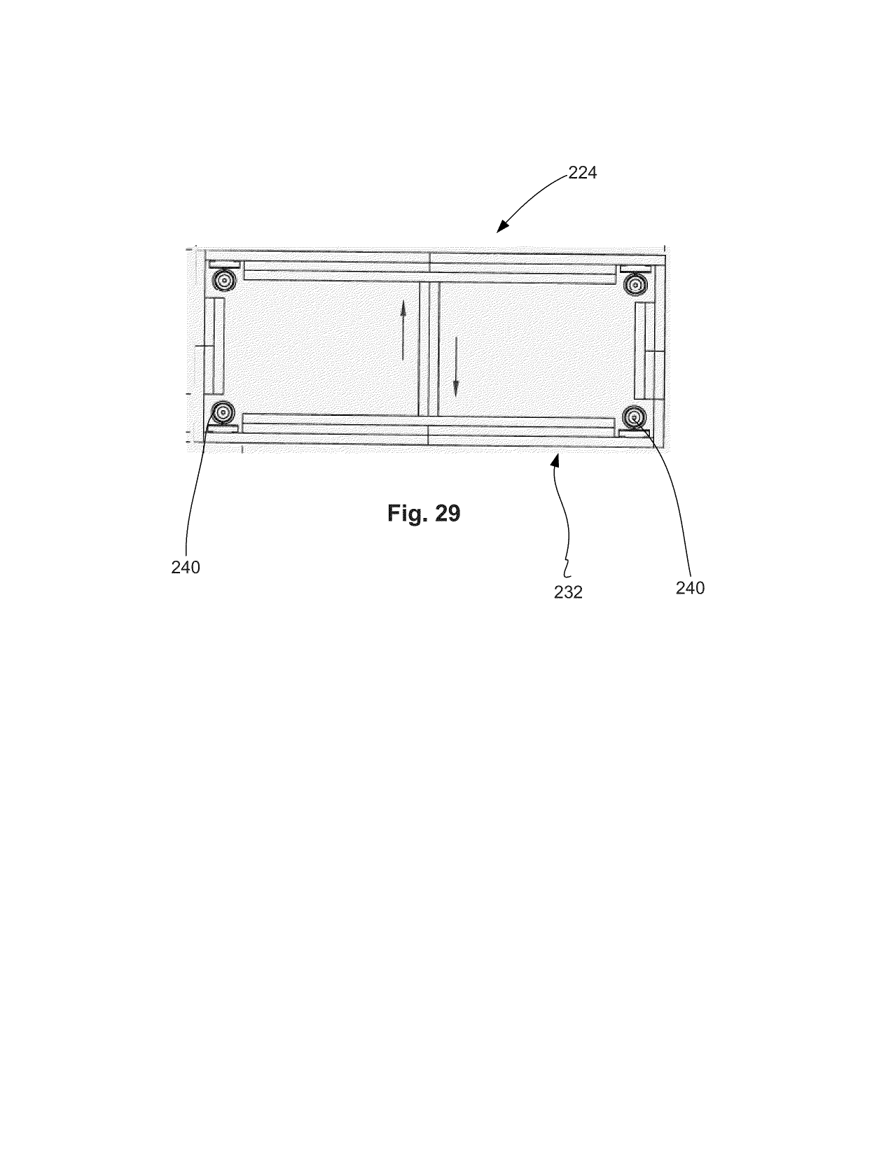

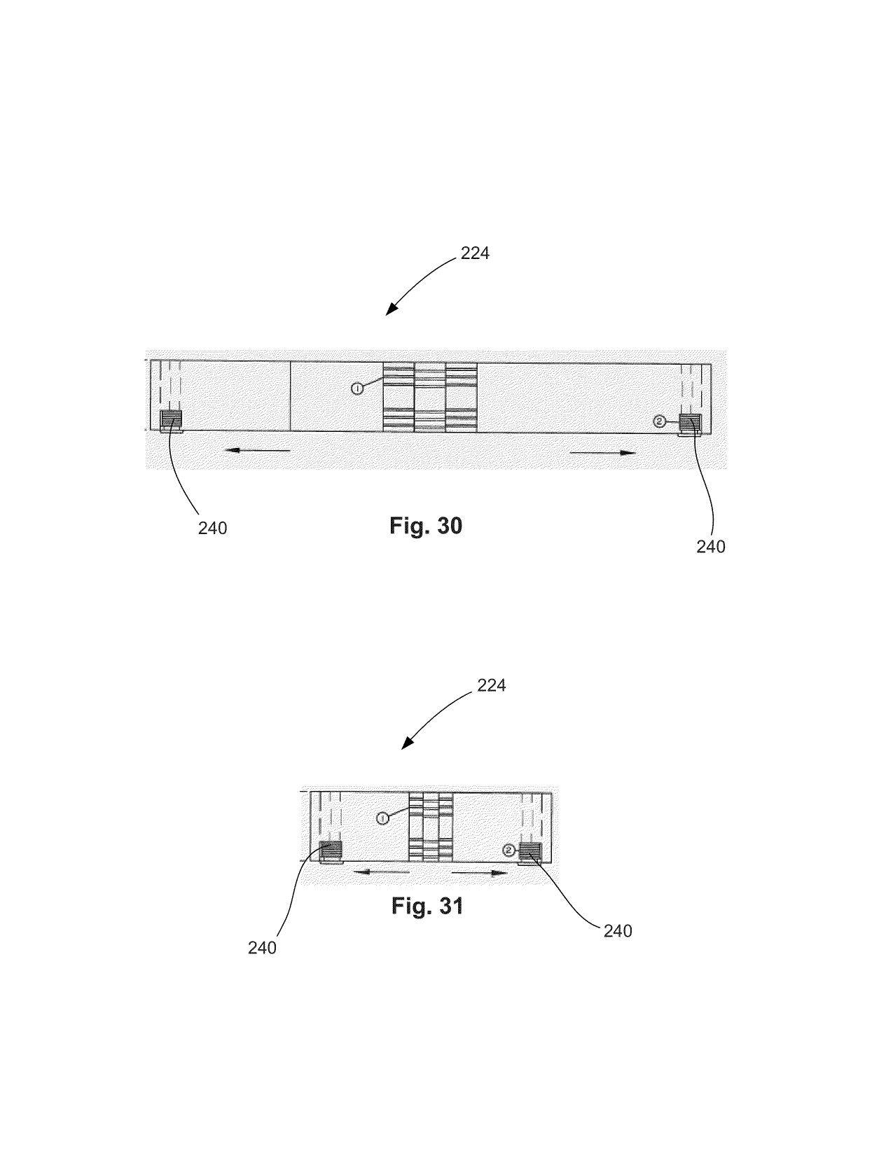

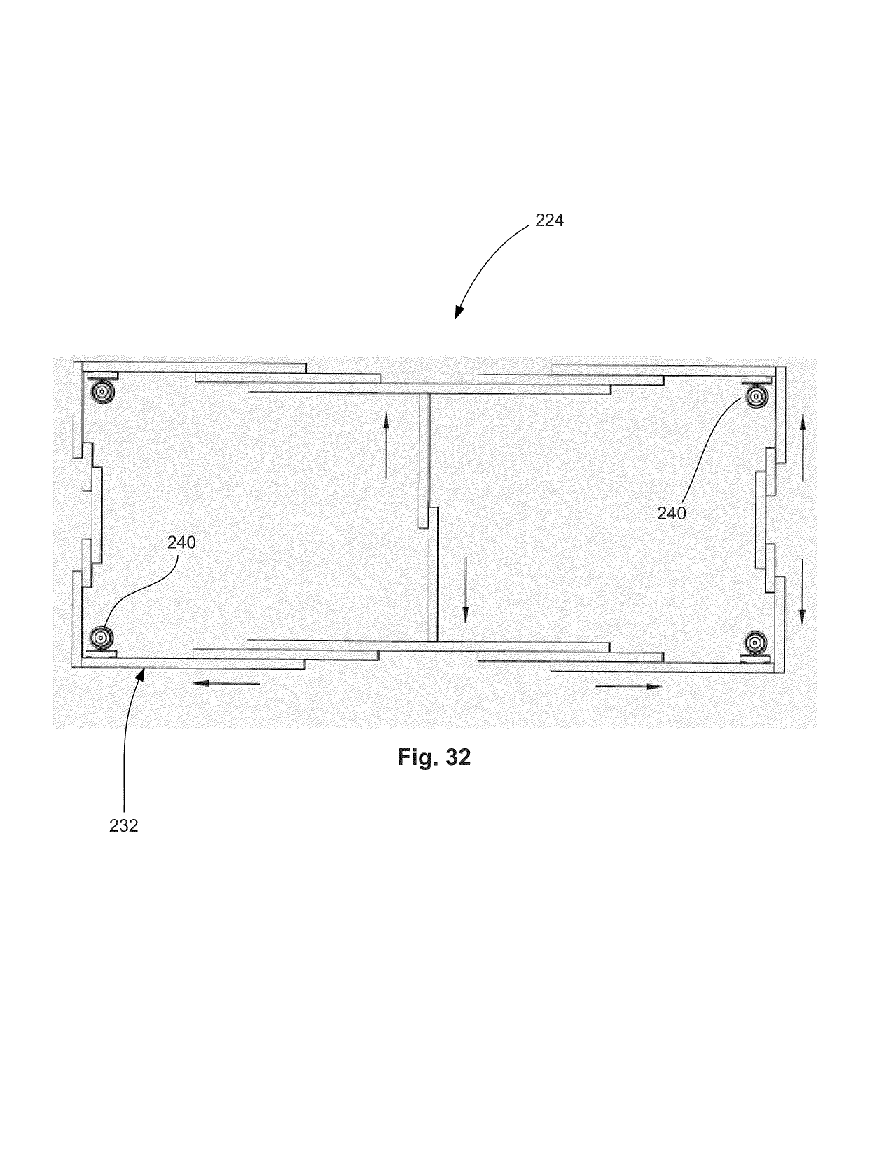

Referring now to FIGS. 25 to 32 and according to another embodiment, there is shown an adjustable pre-fabricated base 224 for receiving a pre-fabricated cabinet 26 (or a pre-fabricated vanity 26). The pre-fabricated cabinet 26 to be received on the adjustable pre-fabricated base 224 has a bottom surface 28 and a corresponding mating portion 30 extending (or downwardly extending) from the bottom surface 28. The adjustable pre-fabricated base 224 includes an adjustable semi-rigid frame 232 for installation on a surface 234. The adjustable semi-rigid frame 232 has an internal surface 236 and an external surface 238. The adjustable semi-rigid frame 232 also includes at least two adjustable members. FIGS. 25, 26, 29 and 32 show an adjustable semi-rigid frame 232, which includes three adjustable members 251, 253, 255 on each side 261, 263, 265 and 267. Each one of the adjustable members 251, 253 and 255 includes at least one mating connector 271 (FIGS. 27 and 28) for slidably connecting with an adjacent corresponding mating connector 273 on an adjacent adjustable member 251, 253 or 255. The sliding members 251, 253 and 255 allow the adjustable semi-rigid frame 232 to be adjustable in any size and configuration depending on the environment (i.e., the kitchen environment or the bathroom environment) that needs to be performed. Moreover, the sliding members 251, 253 and 255 allow the adjustable semi-rigid frame 232 to extend from a retracted position (FIGS. 26 and 29) to an extended position (FIGS. 25 and 32) for an easier transportation of the adjustable pre-fabricated base 224 on the kitchen or bathroom environment or site. The adjustable pre-fabricated base 224 also includes at least two adjustable supporting portions 240 mounted on the adjustable semi-rigid frame 232. It is to be noted that the embodiments shown in FIGS. 25 to 32 includes four adjustable supporting portions 240. In other embodiments, the at least two adjustable supporting portions 240 may be mounted on the internal surface 236 of the adjustable semi-rigid frame 232. It is to be noted that other configurations are also possible. Those adjustable supporting portions 240 allow the adjustable semi-rigid frame 232 to be leveled according to a horizontal plan 242. Thus, the adjustable pre-fabricated base 224 may be installed on any surface even if the surface is not leveled (i.e., in a relatively old house kitchen or bathroom environment or in a non well constructed house kitchen or bathroom environment). The adjustable pre-fabricated base 224 also includes a male and/or female portion 44 (i.e., a mating connector), extending from the external surface 238 (or projecting from the external surface 238 of the adjustable pre-fabricated base 224) of the adjustable semi-rigid frame 232. The male and/or female portion 44 is configured to receive the corresponding mating portion 30 (i.e., to slidably and/or removably receive the corresponding mating portion 30) of the adjustable pre-fabricated cabinet 26 and thereby allows the adjustable pre-fabricated cabinet 26 to be removably mounted on the adjustable semi-rigid frame 232.

According to another embodiment, the surface 234 may be, without limitation, a floor surface, a kitchen floor surface, a bathroom floor surface, a counter surface, a garage surface, an outdoor surface, an indoor surface and the like. However, in a preferred embodiment, the surface 234 is the floor surface of a kitchen environment or of a bathroom environment, which will receive pre-fabricated cabinet(s).

According to a further embodiment, the adjustable supporting portions 240 are mounted on the adjustable semi-rigid frame 232 using a fastener including, without limitation, a screw, a nail, glue, a snap, mating connectors on adjustable semi-rigid frame 232 and corresponding mating connector on adjustable supporting portions 240 and the like.

In another embodiment, the adjustable pre-fabricated base 224 may include an adjustable semi-rigid transverse section 246 transversally mounted on the internal surface 236 of the adjustable semi-rigid frame 232 and the adjustable semi-rigid transverse section 246 may allow the adjustable semi-rigid frame 232 to be substantially rigid. Additionally, the adjustable semi-rigid transverse section includes at least two adjustable members 281, 283 for allowing the adjustable semi-rigid frame 232 to extend from the retracted position (FIGS. 26 and 29) to the extended position (FIGS. 25 and 32). The adjustable members 251, 253, 255 of the adjustable semi-rigid frame 232 (including the adjustable members 281, 283 of the adjustable semi-rigid transverse section 246) extend from the adjustable semi-rigid frame 232. In the adjustable pre-fabricated base 224, the adjustable semi-rigid frame 232 may be made, without limitation, of wood, of plywood, of a polymeric material, of a metallic material, of any combinations and of any other suitable materials.

In a further embodiment, the adjustable pre-fabricated base 224 may further include an adjustable decorative molding 48 (or a non adjustable decorative molding) which has a corresponding mating portion 31 for mounting on the corresponding male and/or female portion 44 extending from the external surface 238 of the adjustable semi-rigid frame 232. The corresponding mating portion 31 may extend on a perpendicularly manner from the adjustable decorative molding 48 such that the decorative molding 48 may be installed via a lateral displacement of the decorative molding 48 towards the pre-fabricated base 224.

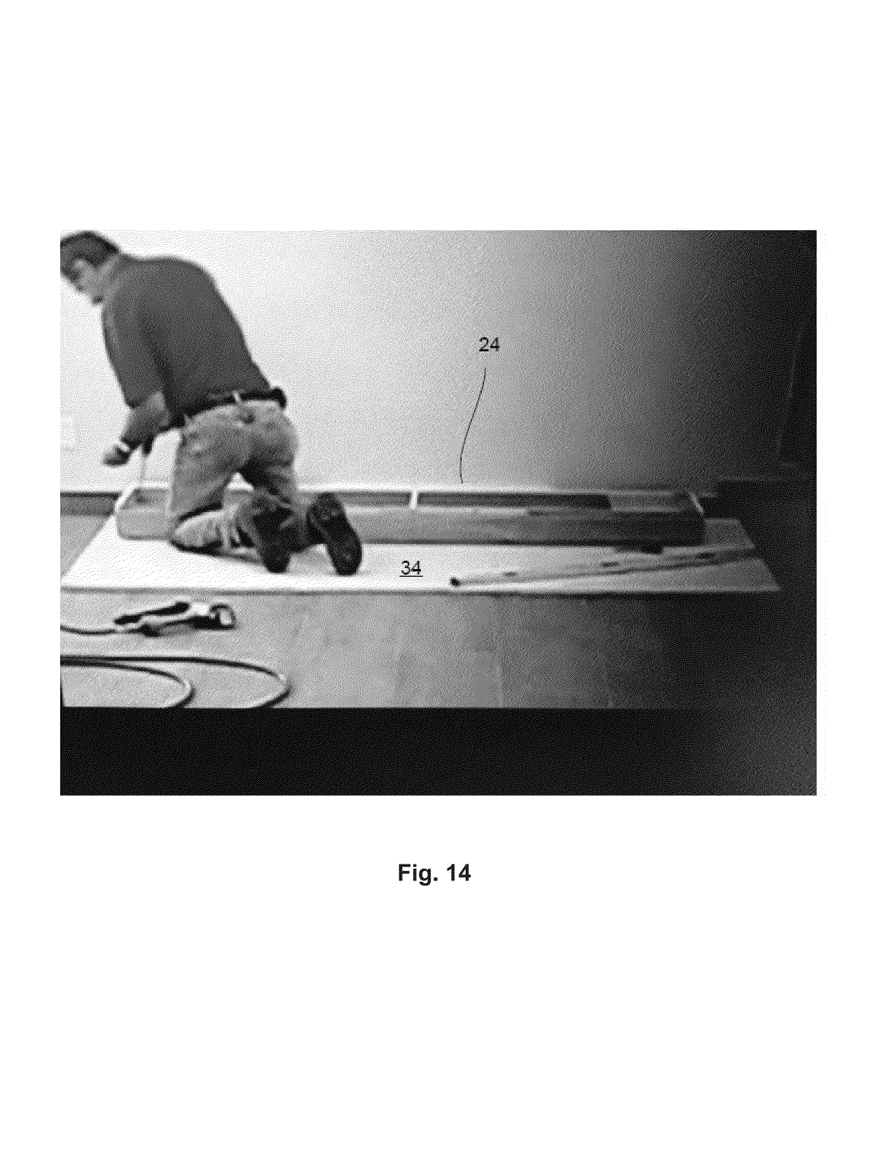

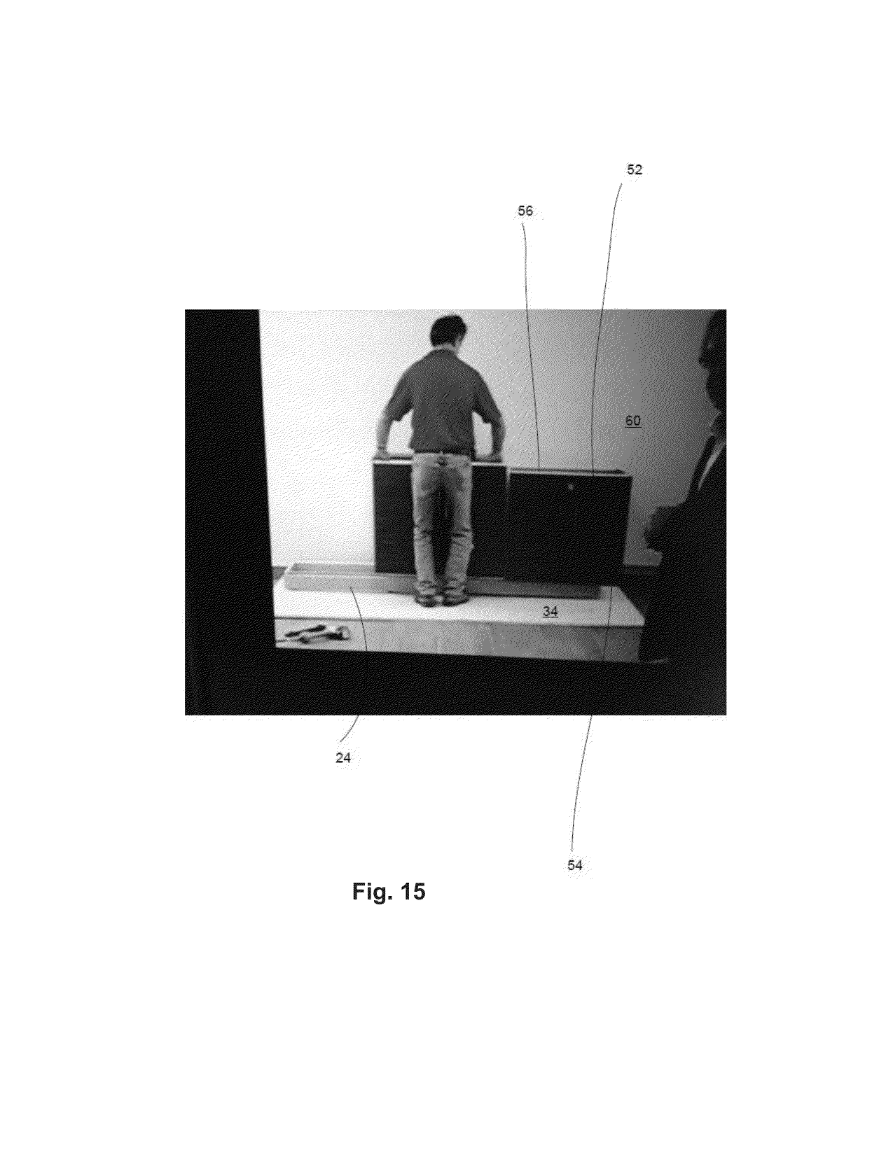

Referring now to FIG. 11 and to FIGS. 12 à 24, there is provided a method 100 for installation of a pre-fabricated environment having at least one bottom cabinet 52 in accordance with an embodiment. The method 100 includes a step 110 of mounting a pre-fabricated base 24 (or an adjustable pre-fabricated base 224) on a surface 34, and where the pre-fabricated base 24 or pre-fabricated adjustable base 224 has a male and/or female portion 44. The method 100 also comprises the step 112 of leveling the pre-fabricated base 24 (or pre-fabricated adjustable base 224) installed on the surface 34 for allowing the pre-fabricated base 24 (or pre-fabricated adjustable base 224) to be leveled according to a horizontal plan 42. The method 100 further includes the step 114 of mounting at least one bottom pre-fabricated cabinet 52 on the pre-fabricated base 24 (or pre-fabricated adjustable base 224), and where the at least one bottom pre-fabricated cabinet 52 has a bottom surface 54, a top surface 56 and a corresponding mating portion 58 extending from the bottom surface 54 for insertion in the male/female portion 44 of the pre-fabricated base 24 (or pre-fabricated adjustable base 224). Moreover, the method 100 includes the step 116 of mounting at least one guiding bar 50 on a wall surface 60 at a specific measured distance 62 from the top surface 56 of the at least one bottom pre-fabricated cabinet 52. The method 100 also includes the step 122 of mounting at least one top pre-fabricated cabinet 64 on the at least one guiding bar 50.

According to another embodiment, the method 100 further includes the step 118 of mounting a counter surface or a counter top (not shown) on the top surface 56 of the at least one bottom cabinet 52.

According to a further embodiment, the method 100 further includes the step 120 of mounting a pre-fabricated backsplash panel 10 on the wall surface 60 over the top surface 56 of the at least one bottom pre-fabricated cabinet 52.

It is to be noted that the at least one top pre-fabricated cabinet 64 and the at least one bottom pre-fabricated cabinet 52 may be, without limitation, a kitchen cabinet, a bathroom cabinet, a kitchen vanity, a bathroom vanity, a cupboard, a filing cabinet, a dresser, a garage cabinet and the like. In a preferred embodiment, the top and bottom pre-fabricated cabinets 64, 52 are bathroom and kitchen cabinets/vanities.

According to another embodiment, the pre-fabricated base 24 mounted on the surface 34 may be fixed on the surface 34. According to a further embodiment, the method 100 may further include the step 124 of mounting at least one decorative molding 48 (or adjustable decorative molding 48) adjacent to the pre-fabricated base 24 (or pre-fabricated adjustable base 224) installed on the surface 34 or directly on the pre-fabricated base 24 (or pre-fabricated adjustable base 224).

According to another embodiment, the surface 34 where the base 24 is mounted may be, without limitation, a floor surface, a kitchen floor surface, a bathroom floor surface, a counter surface, a garage surface, an outdoor surface, an indoor surface and the like.

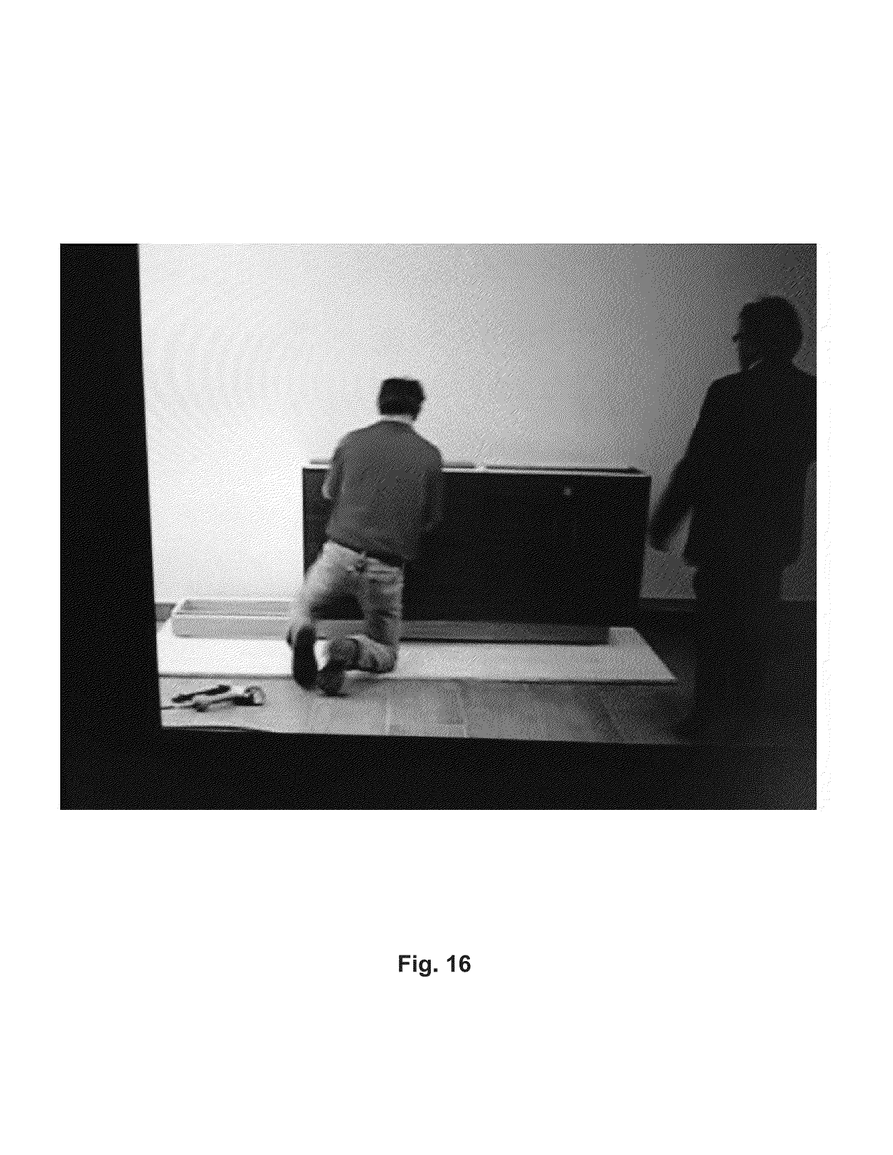

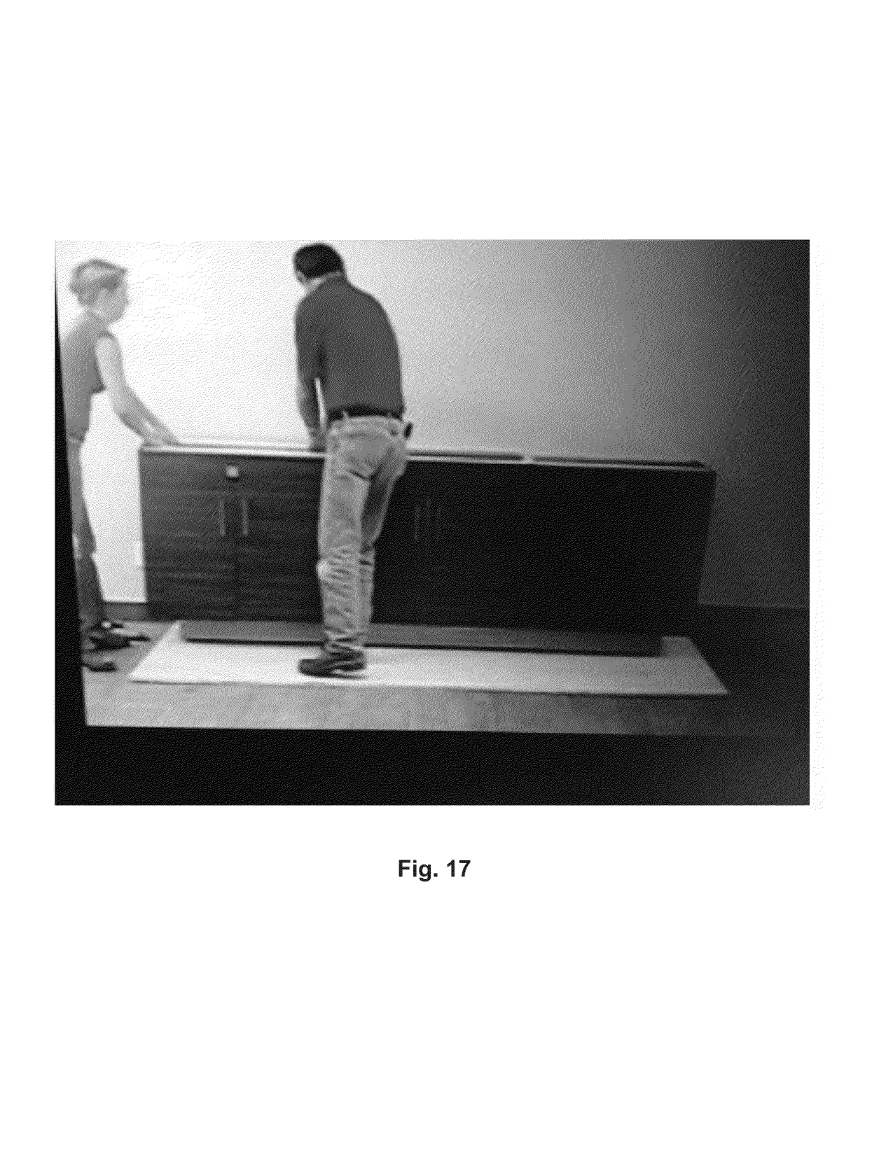

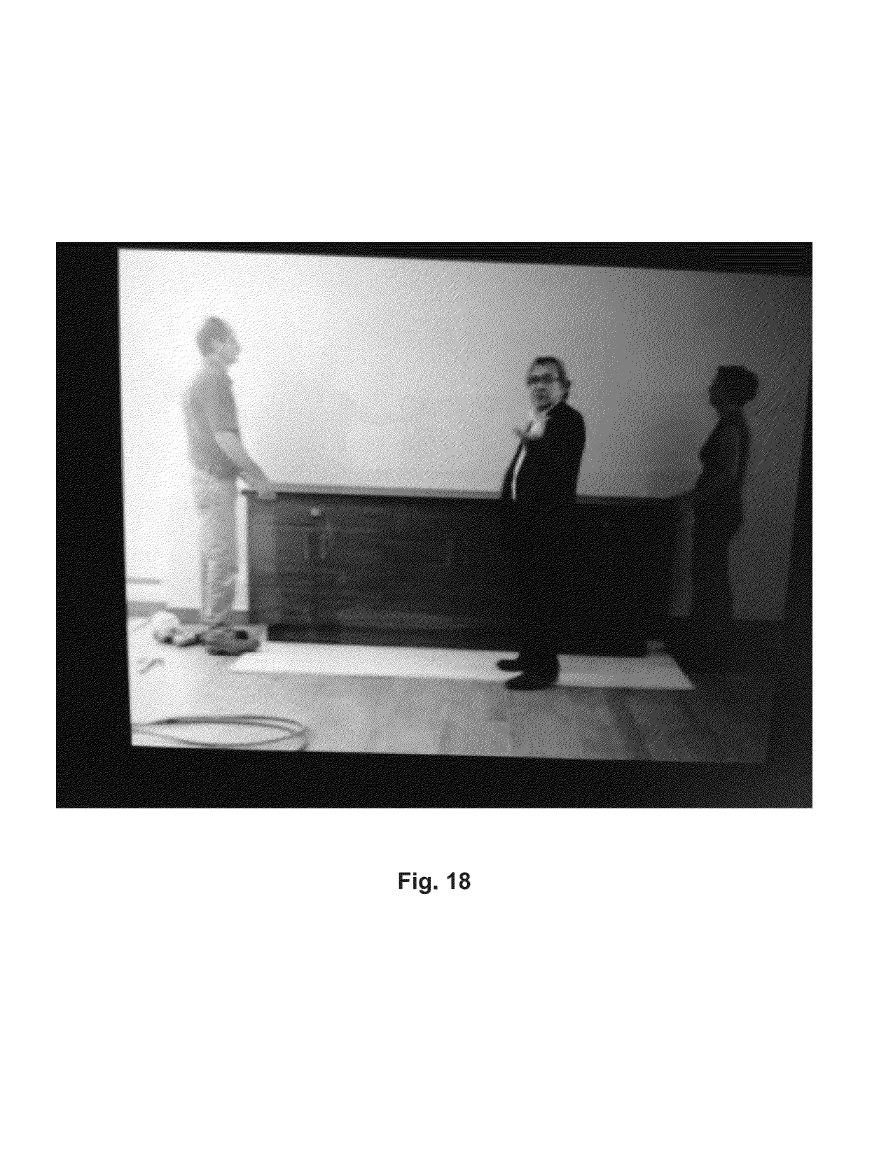

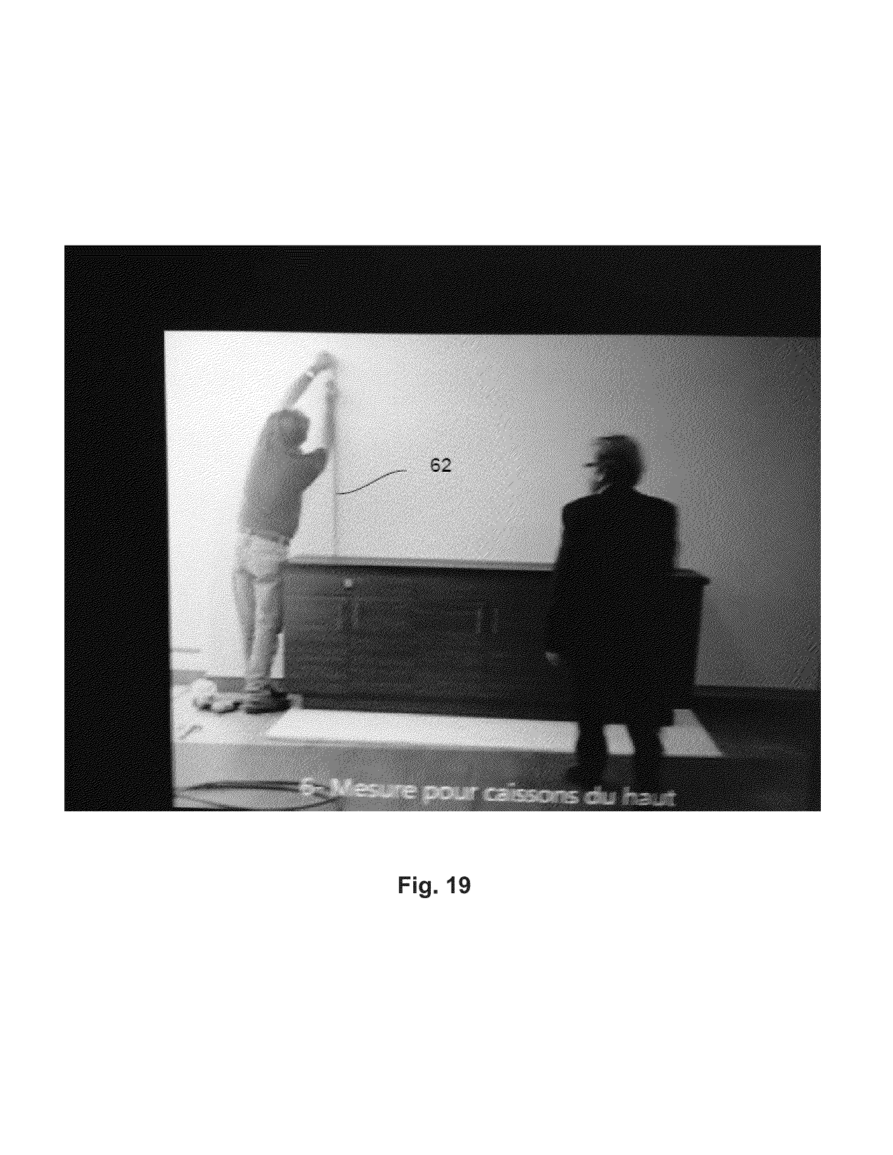

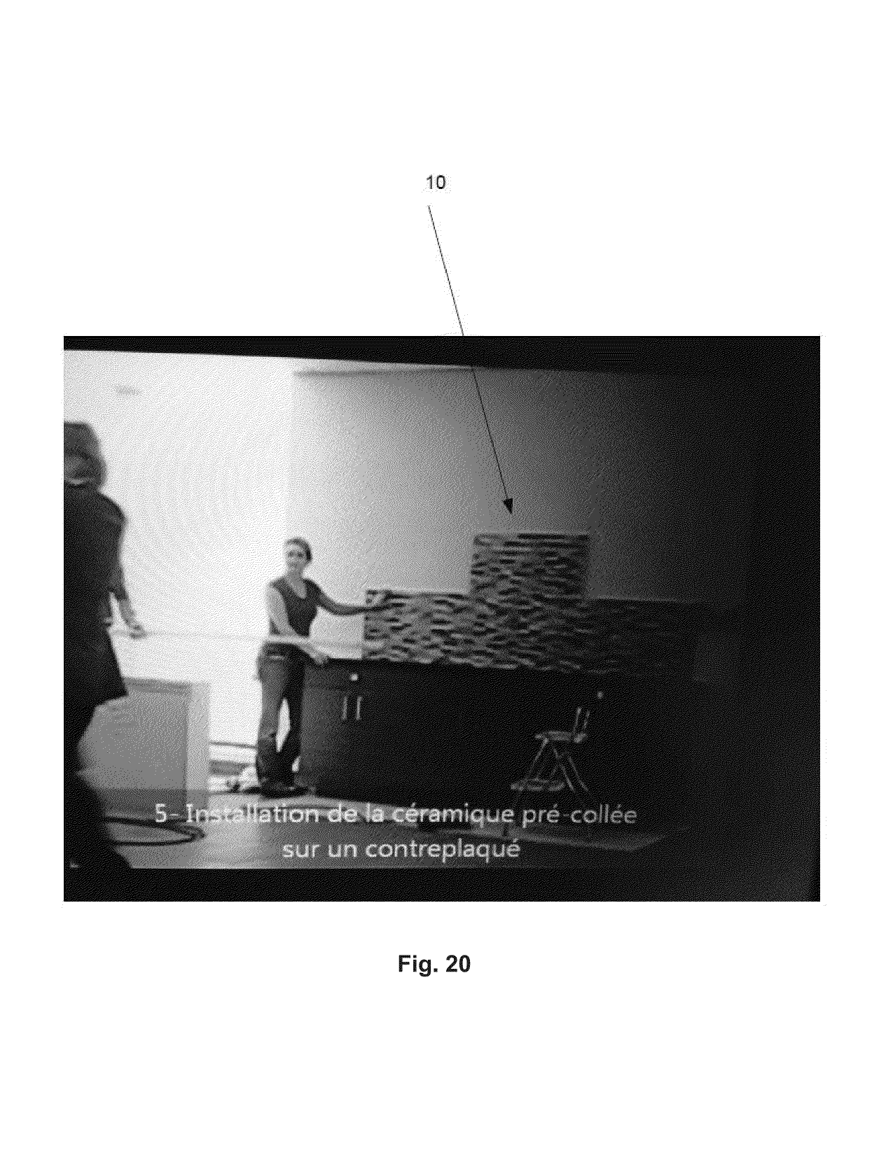

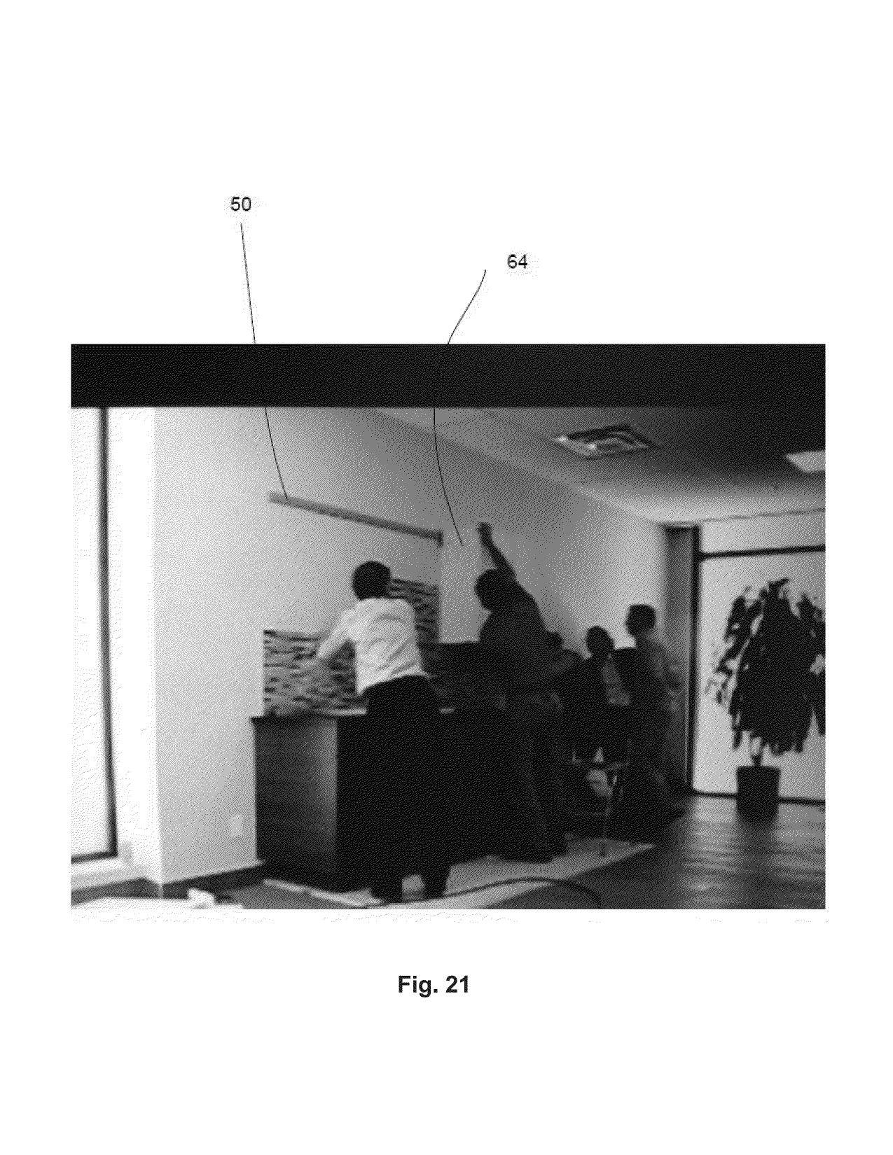

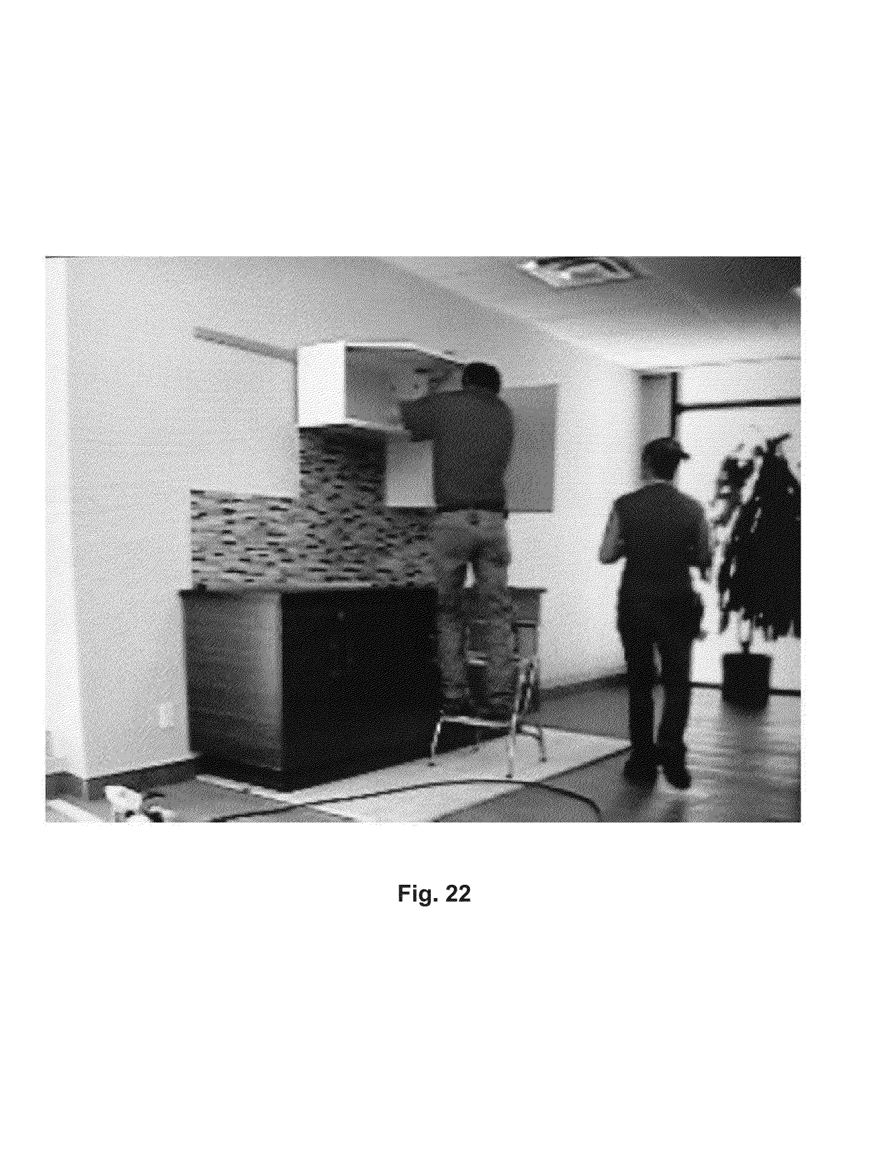

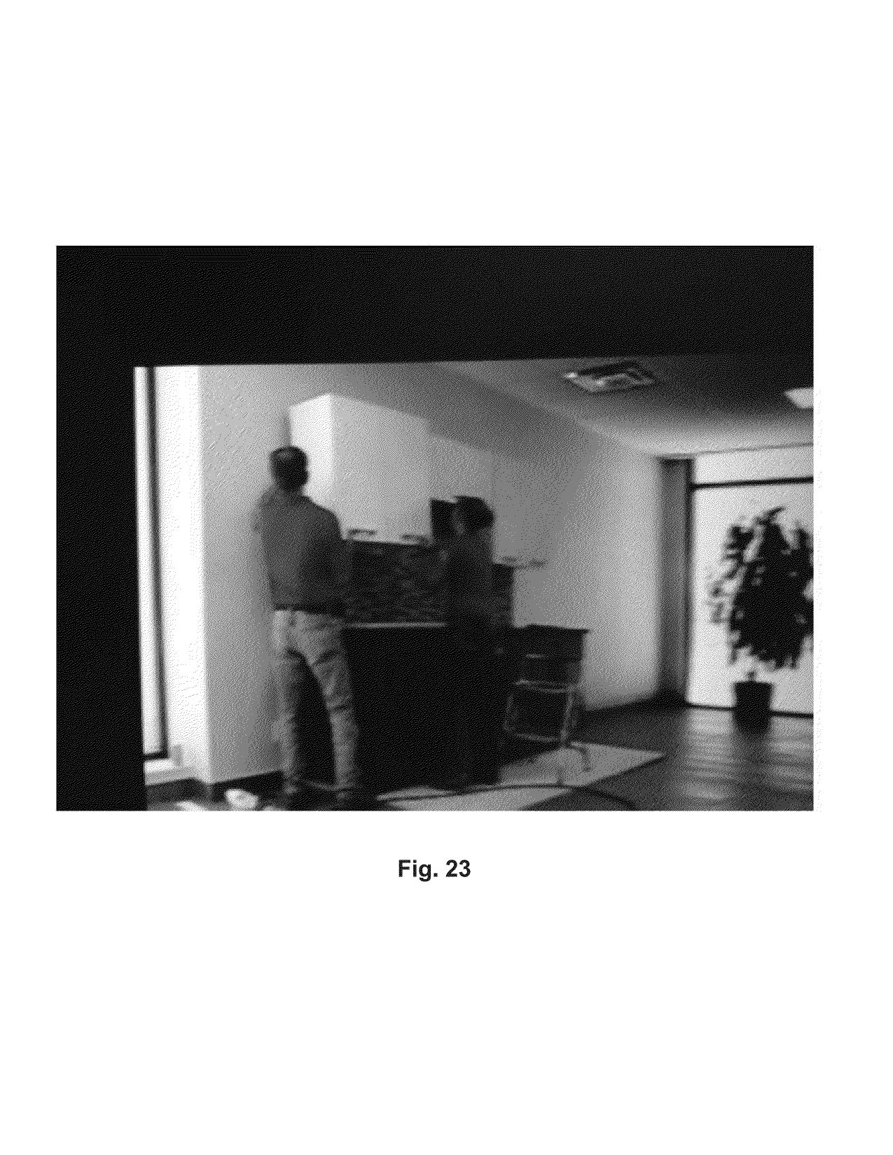

Still referring to FIGS. 12 to 24, there is presented a kit, in accordance with an embodiment, for installation of a pre-fabricated environment having at least one bottom cabinet 52 comprising:
a pre-fabricated base 24 (or pre-fabricated adjustable base 224) having a male/female portion 44;
at least one bottom pre-fabricated cabinet 52 to be mounted on the pre-fabricated base 24 (or pre-fabricated adjustable base 224), the at least one bottom pre-fabricated cabinet 52 having a bottom surface 54, a top surface 56 and a corresponding mating portion 58 extending from the bottom surface 54 to be inserted in the male/female portion 44 of the pre-fabricated base 24 (or pre-fabricated adjustable base 224);
at least one guiding bar 50 to be mounted on a wall surface 60 at a specific measured distance 62 from the top surface 56 of the at least one bottom pre-fabricated cabinet 52; and
at least one top pre-fabricated cabinet 64 to be mounted on the at least one guiding bar 50.

According to another embodiment, the kit may further includes a counter surface (not shown) to be mounted on the top surface 56 of the at least one bottom pre-fabricated cabinet 52.

According to a further embodiment, the kit may further include a pre-fabricated backsplash panel 10 to be mounted on the wall surface 60 over the top surface 56 of the at least one bottom pre-fabricated cabinet 52.

According to yet another embodiment, the kit may further include at least one decorative molding 48 (or adjustable decorative molding 246 as described above) to be mounted adjacent to the pre-fabricated base 24 (or pre-fabricated adjustable base 224) installed on the surface 34 or directly on the base 24.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A pre-fabricated backsplash panel for installation on a surface comprising:
a semi-rigid panel having a mounting side, a decorative side and a predetermined shape, the mounting side of the semi-rigid panel is for installation on the surface; and
at least one decorative surface mounted on the decorative side of the semi-rigid panel for allowing appearance transformation of the surface.

2. The pre-fabricated backsplash panel of claim 1, wherein the mounting side of the semi-rigid panel is for fixe installation or removable installation on the surface.

3. The pre-fabricated backsplash panel of claim 1, wherein the at least one decorative surface is fixedly mounted on the decorative side of the semi-rigid panel.

4. The pre-fabricated backsplash panel of claim 1, wherein the at least one decorative surface comprises a plurality of decorative surfaces comprising at least one pattern of decorative surfaces.

5. The pre-fabricated backsplash panel of claim 1, wherein the mounting side of the semi-rigid panel is to be mounted on the surface using glue, tile grout mortar, adhesive, organic adhesive, nails, screws, seal and any combination thereof.

6. A pre-fabricated base for receiving a pre-fabricated cabinet having a bottom surface and a corresponding mating portion extending from the bottom surface comprising:
a semi-rigid frame for installation on a surface, the semi-rigid frame having an internal surface and an external surface;
at least two adjustable supporting portions mounted on at least one of: the internal surface of the semi-rigid frame and the external surface of the semi-rigid frame for horizontally leveling the semi-rigid frame; and
a male/female portion extending from the external surface of the semi-rigid frame for removably receiving the corresponding mating portion of the cabinet.

7. The pre-fabricated base of claim 6, wherein the at least two adjustable supporting portions are mounted on the semi-rigid frame using a screw, a nail, glue, mating connectors, a snap and any combination thereof.

8. The pre-fabricated base of claim 6, further comprising a semi-rigid transverse section transversally mounted on the internal surface of the semi-rigid frame for allowing the semi-rigid frame to be substantially rigid.

9. The pre-fabricated base of claim 6, wherein the semi-rigid frame is made of wood, plywood, a polymeric material, a metallic material and any combination thereof.

10. The pre-fabricated base of claim 6, further comprising a decorative molding having a corresponding mating portion for mounting on the male/female portion extending from the external surface of the semi-rigid frame.

11. The pre-fabricated base of claim 6, wherein the semi-rigid frame defines a plurality of sides and further wherein at least one of the plurality of sides comprises a plurality of adjustable members for allowing the semi-rigid frame to extend from a retracted position to an extended position.

12. The pre-fabricated base of claim 11, wherein the plurality of adjustable members comprises two adjustable members for allowing the semi-rigid frame to extend from a retracted position to an extended position.

13. The pre-fabricated base of claim 11, wherein each one of the plurality of adjustable members comprises at least one mating connector for slidably connecting with a corresponding mating connector of an adjacent one of the plurality of adjustable members.

14. The pre-fabricated base of claim 11, wherein the plurality of adjustable members comprises three adjustable members for allowing the semi-rigid frame to extend from a retracted position to an extended position.

15. The pre-fabricated base of claim 8, wherein the semi-rigid transverse section transversally mounted on the internal surface of the semi-rigid frame further comprises a plurality of adjustable members for allowing the semi-rigid frame to extend from a retracted position to an extended position.

16. The prefabricated base of claim 15, wherein each one of the plurality of adjustable members of the semi-rigid transverse section comprises at least one mating connector for slidably connecting with a corresponding mating connector of an adjacent one of the plurality of adjustable members the semi-rigid transverse section.

17. A method for installation of a pre-fabricated environment having at least one bottom pre-fabricated cabinet comprising the steps of:
a) horizontally leveling a pre-fabricated base on a surface; and
b) mounting at least one bottom pre-fabricated cabinet on the pre-fabricated base, the at least one bottom pre-fabricated cabinet having a bottom surface, a top surface and a corresponding mating portion extending from the bottom surface for removably receiving the male/female portion of the pre-fabricated base.

18. The method of claim 17, further comprising one or more of the following steps: a step c) of mounting at least one guiding bar on a wall surface at a specific measured distance from the top surface of the at least one bottom pre-fabricated cabinet; a step d) of mounting at least one top pre-fabricated cabinet on the at least one guiding bar; a step of mounting a counter surface on the top surface of the at least one bottom pre-fabricated cabinet; a step of mounting a pre-fabricated backsplash panel on the wall surface over the top surface of the at least one bottom pre-fabricated cabinet; and a step of mounting at least one decorative molding adjacent to the pre-fabricated base installed on the surface or directly on the pre-fabricated base.

19. A kit for installation of a pre-fabricated environment having at least one bottom pre-fabricated cabinet comprising:
a pre-fabricated base having a male/female portion and adjustable portions for horizontal leveling; and
at least one bottom pre-fabricated cabinet to be mounted on the pre-fabricated base, the at least one bottom pre-fabricated cabinet having a bottom surface, a top surface and a corresponding mating portion extending from the bottom surface to removably receive the male/female portion of the pre-fabricated base.

20. The kit of claim 19, further comprising one or more of: at least one guiding bar to be mounted on a wall surface at a specific measured distance from the top surface of the at least one bottom pre-fabricated cabinet; at least one top pre-fabricated cabinet to be mounted on the at least one guiding bar; a counter surface to be mounted on the top surface of the at least one bottom pre-fabricated cabinet; a pre-fabricated backsplash panel to be mounted on the wall surface over the top surface of the at least one bottom pre-fabricated cabinet; and at least one decorative molding to be mounted adjacent to the pre-fabricated base installed on the surface or directly on the pre-fabricated base.
